(19) United States
(12) Patent Application Publication
(10) Pub. No.: US 2025/0310879 A1
(43) Pub. Date: Oct. 2, 2025

(54) METHOD AND APPARATUS FOR SIGNAL MONITORING IN COMMUNICATION SYSTEM

(71) Applicant: ELECTRONICS AND TELECOMMUNICATIONS RESEARCH INSTITUTE, Daejeon (KR)

(72) Inventors: Hoiyoon JUNG, Daejeon (KR); Cheulsoon KIM, Daejeon (KR); Sung-Hyun MOON, Daejeon (KR); Junghoon LEE, Daejeon (KR)

(21) Appl. No.: 19/096,367

(22) Filed: Mar. 31, 2025

(30) Foreign Application Priority Data
Apr. 1, 2024 (KR) 10-2024-0044386
Jun. 20, 2024 (KR) 10-2024-0080409
Sep. 26, 2024 (KR) 10-2024-0131127
Oct. 30, 2024 (KR) 10-2024-0151015
Feb. 3, 2025 (KR) 10-2025-0012991
Mar. 6, 2025 (KR) 10-2025-0029276
Mar. 31, 2025 (KR) 10-2025-0041212

(51) Int. Cl. H04W 52/02; H04W 72/232; H04W 76/28

(52) U.S. Cl. CPC H04W 52/0229; H04W 72/232; H04W 76/28

(57) ABSTRACT

A method of a terminal may comprise: performing a first monitoring operation in a monitoring occasion to receive a low-power wake-up signal; and in response to receipt of the low-power wake-up signal indicating wake-up of the terminal from a base station, performing a physical downlink control channel (PDCCH) monitoring operation after a first offset from a reception time of the low-power wake-up signal.

### CROSS-REFERENCE TO RELATED APPLICATIONS

This application claims priority to Korean Patent Applications No. 10-2024-0044386, filed on Apr. 1, 2024, No. 10-2024-0080409, filed on Jun. 20, 2024, No. 10-2024-0131127, filed on Sep. 26, 2024, No. 10-2024-0151015, filed on Oct. 30, 2024, No. 10-2025-0012991, filed on Feb. 3, 2025, No. 10-2025-0029276, filed on Mar. 6, 2025, and No. 10-2025-0041212, filed on Mar. 31, 2025, with the Korean Intellectual Property Office (KIPO), the entire contents of which are hereby incorporated by reference.

### BACKGROUND

### 1. Technical Field

The present disclosure relates to a signal monitoring technique in a communication system, and more particularly, to a technique for monitoring a low-power signal.

### 2. Related Art

With the advancement of information and communication technology, various wireless communication technologies are being developed. The representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technology. The NR may be a 5^{th} generation (5G) communication technology.

The 5G communication system (e.g., communication system supporting the NR) using a higher frequency band (e.g., a frequency band of 6 GHz or above) than a frequency band (e.g., a frequency band of 6 GHz or below) of the 4G communication system is being considered for processing of soaring wireless data after commercialization of the 4G communication system (e.g., communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

In the 5G communication system, a low-power wake-up signal and a low-power wake-up receiver for receiving the low-power wake-up signal may be considered to reduce power consumption of a terminal. The power consumption for monitoring the low-power wake-up signal in the low-power wake-up receiver may be lower than power consumption for monitoring signals in an existing receiver (e.g., an existing receiver of the terminal).

The terminal may perform a monitoring operation of the low-power wake-up signal through the low-power wake-up receiver for the purpose of power reduction. If the low-power wake-up signal is received through the low-power wake-up receiver of the terminal, the terminal may perform a monitoring operation of signals using the existing receiver. To support the above-described operations, monitoring methods for the low-power wake-up signal in the communication system may be required.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing to a method and an apparatus for monitoring a low-power signal in a communication system.

A method of a terminal, according to exemplary embodiments of the present disclosure, may comprise: performing a first monitoring operation in a monitoring occasion to receive a low-power wake-up signal; and in response to receipt of the low-power wake-up signal indicating wake-up of the terminal from a base station, performing a physical downlink control channel (PDCCH) monitoring operation after a first offset from a reception time of the low-power wake-up signal.

The method may further comprise: receiving configuration information for the first monitoring operation from the base station, wherein the configuration information includes at least one of a cycle or an offset of the monitoring occasion.

Each of the cycle or the offset of the monitoring occasion may be set independently from a cycle or an offset of a discontinuous reception (DRX) configured for the terminal.

The performing of the PDCCH monitoring operation may comprise: starting a first timer after the first offset from the reception time of the low-power wake-up signal; and performing the PDCCH monitoring operation in a time duration corresponding to the first timer.

The method may further comprise: in response to that the low-power wake-up signal is not received from the base station or that the low-power wake-up signal received from the base station does not indicate wake-up of the terminal, performing the first monitoring operation for receiving the low-power wake-up signal in the monitoring occasion of a next cycle.

The PDCCH monitoring operation may be performed to receive a paging message from the base station.

The first offset may be configured to the terminal by signaling of the base station.

The first monitoring operation may be performed by a low-power receiver included in the terminal, and the PDCCH monitoring operation may be performed by a main radio included in the terminal.

When the terminal supports a carrier aggregation operation and the low-power wake-up signal is received from one serving cell, a wake-up indication according to the low-power wake-up signal may be applied to all serving cells.

When the terminal supports a dual connectivity operation and the low-power wake-up signal is received from one serving cell within a cell group, a wake-up indication according to the low-power wake-up signal may be applied to all serving cells within the cell group.

A terminal, according to exemplary embodiments of the present disclosure, may comprise at least one processor, wherein the at least one processor may cause the terminal to perform: performing a first monitoring operation in a monitoring occasion to receive a low-power wake-up signal; and in response to receipt of the low-power wake-up signal indicating wake-up of the terminal from a base station, performing a physical downlink control channel (PDCCH) monitoring operation after a first offset from a reception time of the low-power wake-up signal.

The at least one processor may further cause the terminal to perform: receiving configuration information for the first monitoring operation from the base station, wherein the configuration information includes at least one of a cycle or an offset of the monitoring occasion.

Each of the cycle or the offset of the monitoring occasion may be set independently from a cycle or an offset of a discontinuous reception (DRX) configured for the terminal.

In the performing of the PDCCH monitoring operation, the at least one processor may cause the terminal to perform: starting a first timer after the first offset from the reception time of the low-power wake-up signal; and performing the PDCCH monitoring operation in a time duration corresponding to the first timer.

The at least one processor may further cause the terminal to perform: in response to that the low-power wake-up signal is not received from the base station or that the low-power wake-up signal received from the base station does not indicate wake-up of the terminal, performing the first monitoring operation for receiving the low-power wake-up signal in the monitoring occasion of a next cycle.

The PDCCH monitoring operation may be performed to receive a paging message from the base station.

The first offset may be configured to the terminal by signaling of the base station.

The terminal may further comprise a low-power receiver and a main radio, wherein the first monitoring operation may be performed by the low-power receiver, and the PDCCH monitoring operation may be performed by the main radio.

When the terminal supports a carrier aggregation operation and the low-power wake-up signal is received from one serving cell, a wake-up indication according to the low-power wake-up signal may be applied to all serving cells.

When the terminal supports a dual connectivity operation and the low-power wake-up signal is received from one serving cell within a cell group, a wake-up indication according to the low-power wake-up signal may be applied to all serving cells within the cell group.

According to the present disclosure, the terminal may perform a monitoring operation in a monitoring occasion to receive a low-power wake-up signal. If a low-power wake-up signal indicating wake-up of the terminal is received, the terminal may perform a physical downlink control channel (PDCCH) monitoring operation. Based on the above-described operations, a signal monitoring method in the terminal can be improved, the power consumption of the terminal can be reduced, and the performance of the communication system can be enhanced.

### BRIEF DESCRIPTION OF DRAWINGS

FIG. 1 is a conceptual diagram illustrating exemplary embodiments of a communication network.

FIG. 2 is a block diagram illustrating exemplary embodiments of a communication node constituting a communication network.

FIG. 3 is a conceptual diagram illustrating exemplary embodiments of a system frame in a communication network.

FIG. 4 is a conceptual diagram illustrating exemplary embodiments of a subframe in a communication network.

FIG. 5 is a conceptual diagram illustrating exemplary embodiments of a slot in a communication network.

FIG. 6 is a conceptual diagram illustrating exemplary embodiments of signal monitoring operations in a communication network.

FIG. 7 is a conceptual diagram illustrating exemplary embodiments of RRC state transitions of a terminal in a communication network.

FIG. 8 is a block diagram illustrating exemplary embodiments of a communication node constituting a communication network.

FIG. 9 is a conceptual diagram illustrating exemplary embodiments of a low-power monitoring operation in a communication network.

FIG. 10 is a conceptual diagram illustrating exemplary embodiments of a low-power monitoring operation in a communication network.

FIG. 11 is a conceptual diagram illustrating exemplary embodiments of a low-power monitoring operation in a communication network.

FIG. 12 is a conceptual diagram illustrating exemplary embodiments of a low-power monitoring operation in a communication network.

FIG. 13 is a conceptual diagram illustrating exemplary embodiments of a low-power monitoring operation in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, ‘time’ and ‘time point’ may be used interchangeably. ‘Time’ may be interpreted as either time or a time point depending on a context, and ‘time point’ may be interpreted as either time or a time point depending on a context.

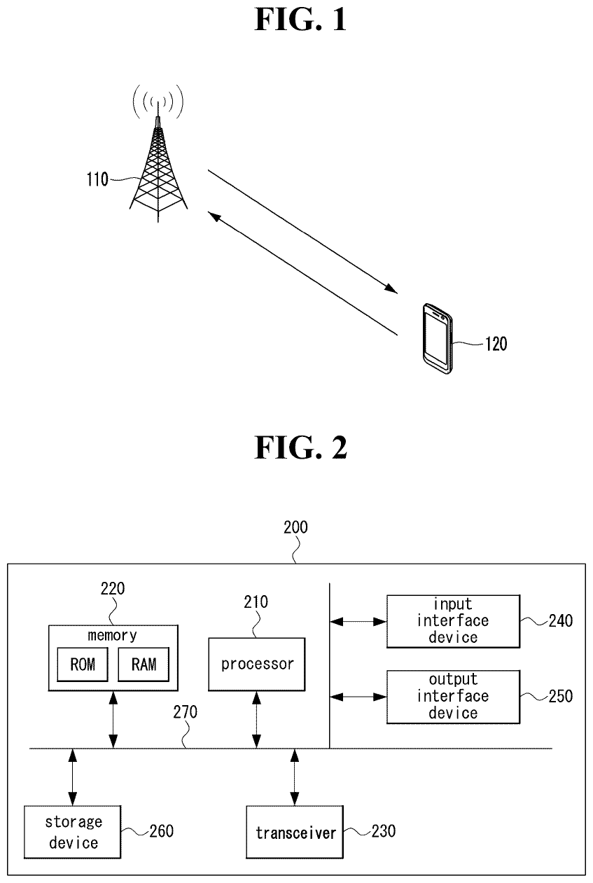

FIG. 1 is a conceptual diagram illustrating exemplary embodiments of a communication network.

Referring to FIG. 1, a base station 110 may support cellular communication (e.g., long term evolution (LTE), LTE-advance (LTE-A), LTE-A Pro, LTE-unlicensed (LTE-U), new radio (NR), and NR-unlicensed (NR-U) specified as the 3rd generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (COMP), carrier aggregation (CA), or the like. A terminal 120 may perform communication (e.g., uplink communication and/or downlink communication) with the base station 110.

A first terminal 120 and a second terminal 130 may perform sidelink communication. The sidelink communication may be performed based on a mode 1 or mode 2. When the mode 1 is used, sidelink communication between the first terminal 120 and the second terminal 130 may be performed using resource(s) allocated by the base station 110. When the mode 2 is used, sidelink communication between the first terminal 120 and the second terminal 130 may be performed using resource(s) selected by the first terminal 120 or the second terminal 130.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

FIG. 2 is a block diagram illustrating exemplary embodiments of a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Hereinafter, operation methods of a communication node in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal.

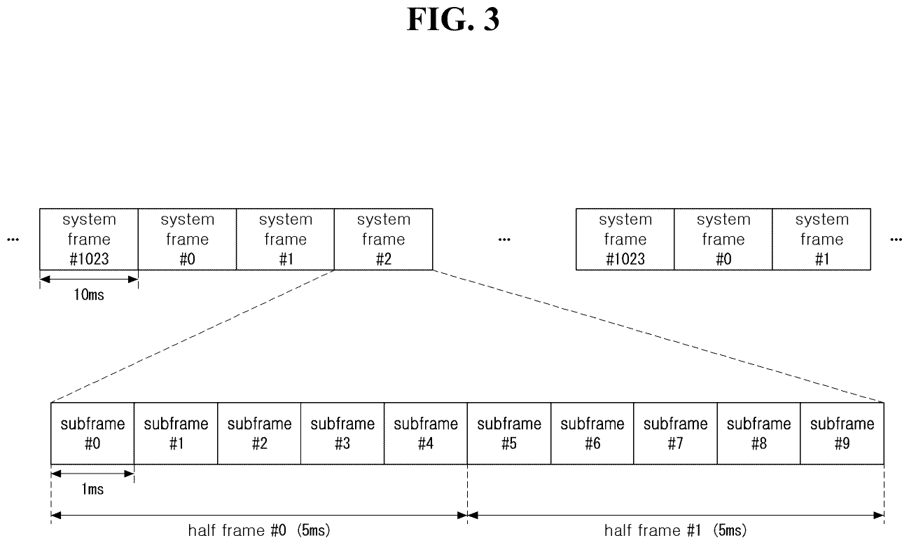

FIG. 3 is a conceptual diagram illustrating exemplary embodiments of a system frame in a communication network.

Referring to FIG. 3, time resources in a communication network may be divided into frames. For example, system frames each of which has a length of 10 milliseconds (ms) may be configured consecutively in the time domain of the communication network. System frame numbers (SFNs) may be set to #0 to #1023. In this case, 1024 system frames may be repeated in the time domain of the communication network. For example, an SFN of a system frame after the system frame #1023 may be set to #0.

One system frame may comprise two half frames, and the length of one half frame may be 5 ms. A half frame located in a starting region of a system frame may be referred to as a ‘half frame #0’, and a half frame located in an ending region of the system frame may be referred to as a ‘half frame #1’. The system frame may include 10 subframes, and the length of one subframe may be 1 ms. 10 subframes within one system frame may be referred to as ‘subframes #0 to #9’.

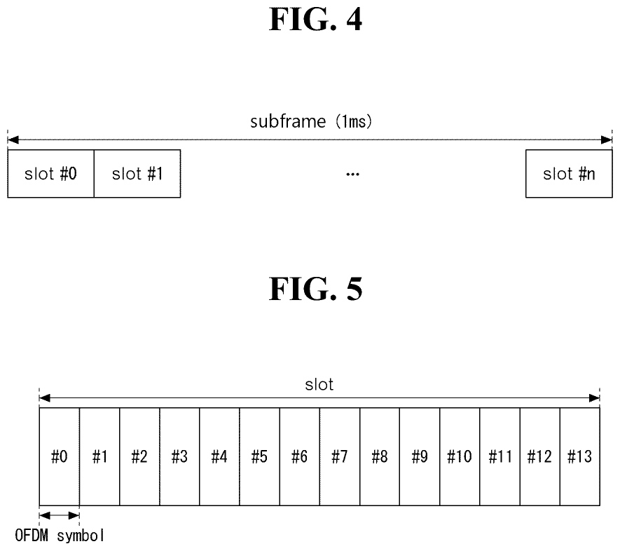

FIG. 4 is a conceptual diagram illustrating exemplary embodiments of a subframe in a communication network.

Referring to FIG. 4, one subframe may include n slots, and n may be a natural number. Accordingly, one subframe may be composed of one or more slots.

FIG. 5 is a conceptual diagram illustrating exemplary embodiments of a slot in a communication network.

Referring to FIG. 5, one slot may comprise one or more symbols. One slot shown in FIG. 5 may be composed of 14 symbols. Here, the length of the slot may vary depending on the number of symbols included in the slot and the length of the symbol. Alternatively, the length of the slot may vary according to a numerology. When a subcarrier spacing is 15 kHz (e.g., μ=0), the length of the slot may be 1 ms. In this case, one system frame may include 10 slots. When the subcarrier spacing is 30 kHz (e.g., μ=1), the length of the slot may be 0.5 ms. In this case, one system frame may include 20 slots.

When the subcarrier spacing is 60 kHz (e.g., μ=2), the length of the slot may be 0.25 ms. In this case, one system frame may include 40 slots. When the subcarrier spacing is 120 kHz (e.g., μ=3), the length of the slot may be 0.125 ms. In this case, one system frame may include 80 slots. When the subcarrier spacing is 240 kHz (e.g., μ=4), the length of the slot may be 0.0625 ms. In this case, one system frame may include 160 slots.

A symbol may be configured as a downlink symbol, a flexible symbol, or an uplink symbol. A slot consisting only of downlink (DL) symbols may be referred to as a ‘DL slot’, a slot consisting only of flexible (FL) symbols may be referred to as an ‘FL slot’, and a slot consisting only of uplink (UL) symbols may be referred to as a ‘UL slot’.

A reference signal may be a channel state information-reference signal (CSI-RS), a sounding reference signal (SRS), a demodulation-reference signal (DM-RS), a phase tracking-reference signal (PT-RS), or the like. A channel may be a physical downlink control channel (PDCCH), a physical downlink shared channel (PDSCH), a physical uplink control channel (PUCCH), a physical uplink shared channel (PUSCH), a physical sidelink control channel (PSCCH), a physical sidelink shared channel (PSSCH), or the like. In the present disclosure, a control channel may refer to a PDCCH, a PUCCH, or a PSCCH, and a data channel may refer to a PDSCH, a PUSCH, or a PSSCH.

Hereinafter, methods for transmitting and receiving signals in a communication network (e.g., communication system) will be described. In downlink communication, downlink data may be transmitted through a physical downlink shared channel (PDSCH). In uplink communication, uplink data may be transmitted through a physical uplink shared channel (PUSCH). In the present disclosure, a PDSCH may refer to downlink data or a resource in which the downlink data is transmitted and received, and a PUSCH may refer to uplink data or a resource in which the uplink data is transmitted and received. A base station may transmit downlink control information (DCI) including configuration information (e.g., resource allocation information, scheduling information) of a PDSCH on a physical downlink control channel (PDCCH). In the present disclosure, a PDCCH may refer to a DCI (e.g., control information) or a resource in which the DCI is transmitted.

A terminal may receive the DCI on the PDCCH and identify the configuration information of the PDSCH included in the DCI. For example, the configuration information of the PDSCH may include time domain resource assignment (TDRA), frequency domain resource assignment (FDRA), information on a feedback transmission resource for the PDSCH, and/or modulation and coding scheme (MCS) information. The TDRA may indicate a resource region of the PDSCH in the time domain. The FDRA may indicate a resource region of the PDSCH in the frequency domain. The MCS information may indicate an MCS level or MCS index.

A base station may configure bandwidth part(s) (BWP(s)) for downlink communication. The BWP(s) may be configured differently for each terminal. The base station may notify a terminal of BWP configuration information using higher layer signaling. The number of BWPs configured for a terminal may be one or more. The terminal may receive the BWP configuration information from the base station and identify the BWP(s) configured by the base station based on the BWP configuration information. When multiple BWPs are configured for downlink communication, the base station may activate one or more BWPs among the multiple BWPs. The base station may transmit configuration information of the activated BWP(s) to the terminal using at least one of higher layer signaling, a medium access control (MAC) control element (CE), or DCI. The base station may perform downlink communication using the activated BWP(s). The terminal may identify the activated BWP(s) by receiving the configuration information of the activated BWP(s) from the base station and perform downlink reception operations (e.g., downlink communication) in the activated BWP(s).

In the present disclosure, methods for monitoring PDCCH(s) will be described. The terminal may perform a monitoring operation for PDCCH(s) to receive a PDSCH transmitted from the base station. The monitoring operation for PDCCH(s) may be referred to as a PDCCH monitoring operation. The base station may notify the terminal of configuration information for the PDCCH monitoring operation using a higher layer message (e.g., radio resource control (RRC) message). The configuration information for the PDCCH monitoring operation may include control resource set (CORESET) information and/or search space information.

The CORESET information may include PDCCH DM-RS information, precoding information of PDCCH, PDCCH occasion information, and the like. A PDCCH DM-RS may be a DM-RS used for demodulating a PDCCH. A PDCCH occasion may be a region where a PDCCH can exist. In other words, a PDCCH occasion may be a region where DCI can be transmitted. The PDCCH occasion information may include time resource information and/or frequency resource information of PDCCH occasion(s). In the time domain, the length of the PDCCH occasion may be indicated in symbol units. In the frequency domain, the size of the PDCCH occasion may be indicated in RB units (e.g., physical resource block (PRB) units or common resource block (CRB) units).

The search space information may include a CORESET identifier (ID) associated with a search space, a cycle and/or offset of PDCCH monitoring. Each of the cycle and offset of PDCCH monitoring may be indicated in slot units. The search space information may further include an index of a symbol where the PDCCH monitoring operation starts.

Then, paging methods in a communication network will be described. States (e.g., RRC states) of a terminal may be classified into an RRC connected state, an RRC inactive state, and an RRC idle state according to an RRC configuration (e.g., RRC connection) with a base station. A state of the terminal may change according to the RRC configuration with the base station. For example, when the terminal establishes an RRC connection with the base station, the state of the terminal may be the RRC connected state. When the RRC connection between the terminal and the base station is released, the state of the terminal may transition to the RRC idle state. When the RRC connection between the terminal and the base station is suspended, the state of the terminal may transition to the RRC inactive state.

A signal monitoring operation of the terminal may vary depending on the state of the terminal (e.g., RRC connected state, RRC inactive state, RRC idle state). The terminal may perform a signal monitoring operation based on the configuration of the CORESET and the search spaces in the RRC connected state. The terminal may periodically perform a signal monitoring operation in specific time durations according to a configuration of the terminal in the RRC inactive state or the RRC idle state, and may not perform a signal monitoring operation in the remaining time durations. Not performing a signal monitoring operation may mean that the terminal operates in a sleep mode. Performing a signal monitoring operation may mean that the terminal operates in an active mode. The terminal may perform signal monitoring in specific time durations according to a configuration of the base station in the RRC connected state and may operate in the sleep mode by not performing signal monitoring in the remaining time durations outside the specific time durations.

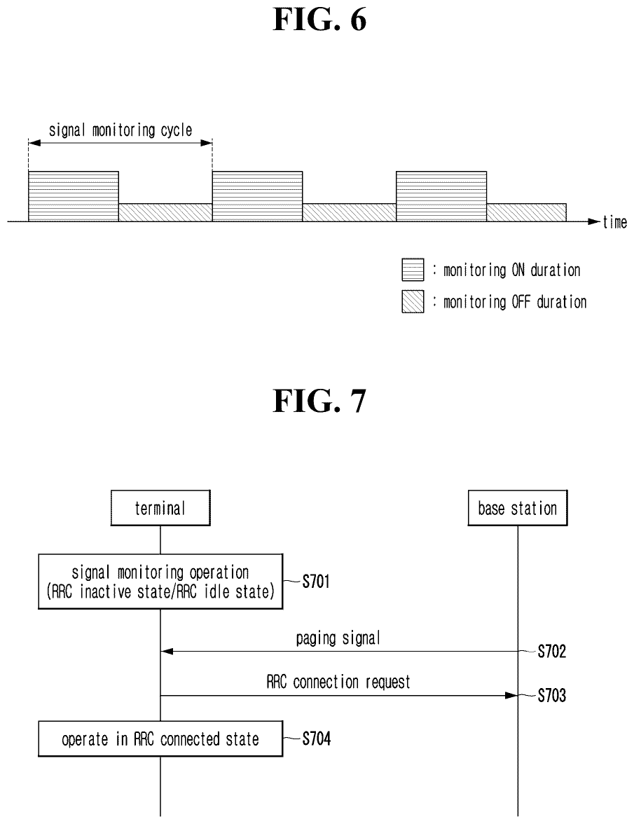

FIG. 6 is a conceptual diagram illustrating exemplary embodiments of signal monitoring operations in a communication network.

Referring to FIG. 6, a terminal may periodically perform a signal monitoring operation over an entire time duration. The signal monitoring operation may be performed within a signal monitoring duration. The signal monitoring duration may periodically exist. The signal monitoring duration may be divided into a signal monitoring ON duration and a signal monitoring OFF duration. A base station may transmit configuration information of the signal monitoring duration to the terminal through signaling. The terminal may receive the configuration information of the signal monitoring duration through signaling from the base station. The configuration information of the signal monitoring duration may include at least one of a time length of a single signal monitoring duration, a cycle of the signal monitoring duration, or a time offset of the signal monitoring duration. The time offset may be referred to as an offset. The offset may be interpreted as a time offset or a frequency offset depending on a context. The signal monitoring duration may include a signal monitoring ON duration and a signal monitoring OFF duration. The signal monitoring ON duration may be referred to as an ON duration, and the signal monitoring OFF duration may be referred to as an OFF duration. The configuration information of the signal monitoring duration may include information on the ON duration and/or information on the OFF duration. The terminal may perform the signal monitoring operation in the ON duration. The terminal may not perform the signal monitoring operation in the OFF duration. Since the signal monitoring operation of the terminal is not performed in the OFF duration within the signal monitoring duration, power consumption of the terminal may be reduced.

FIG. 7 is a conceptual diagram illustrating exemplary embodiments of RRC state transitions of a terminal in a communication network.

Referring to FIG. 7, the terminal may perform the signal monitoring operation in the RRC inactive state or RRC idle state (S701). The terminal may periodically perform the signal monitoring operation. The signal monitoring operation may be a monitoring operation for a paging signal. The base station may transmit a paging signal to the terminal (e.g., terminal in the RRC inactive state or RRC idle state) (S702). A time at which the base station transmits the paging signal may be within a signal monitoring duration of the terminal (e.g., the ON duration within the signal monitoring duration). The terminal may receive the paging signal from the base station. The terminal receiving the paging signal may transmit an RRC connection request to the base station (S703). A signal monitoring operation of the terminal after receiving the paging signal may be different from the signal monitoring operation before receiving the paging signal. To transition the RRC state of the terminal, the terminal may transmit and receive signals with the base station. Based on the above-described operations, the RRC state of the terminal may transition to the RRC connected state. Then, the terminal may operate in the RRC connected state (S704).

The terminal may monitor a paging signal in the RRC inactive state or RRC idle state. The signal monitoring operation for paging may be performed in the same or a similar manner as in the exemplary embodiment of FIG. 6. The base station may transmit paging configuration information to the terminal through signaling. The paging configuration information may be included in a system information block (SIB) transmitted by the base station. The terminal may receive the paging configuration information through signaling from the base station. The paging configuration information may include at least one of a monitoring cycle for paging monitoring, a time offset of the monitoring cycle, or a length of a signal monitoring duration for paging. Paging (e.g., paging signal, paging message) may be transmitted through DCI. The terminal may perform PDCCH monitoring (e.g., paging occasion (PO) monitoring) to receive the paging signal.

The terminal may periodically perform the monitoring operation to receive paging in the RRC inactive state or RRC idle state. The terminal may not receive signals during a duration in which paging is not monitored. Based on the above-described operations, power consumption of the terminal may be reduced.

The terminal in the RRC connected state may use a signal monitoring scheme for reducing power consumption. The terminal in the RRC connected state may perform signal monitoring based on the same or a similar method as in the exemplary embodiment of FIG. 6. The terminal may receive a signal by performing signal monitoring according to a preconfigured cycle. If a signal is received through the signal monitoring according to the preconfigured cycle, the terminal may perform a signal reception operation for a certain time duration. If a signal is not received (e.g., detected) through the signal monitoring according to the preconfigured cycle, the operating state of the terminal may transition to a sleep mode until the next signal monitoring cycle. The terminal in the sleep mode may not perform the signal monitoring operation. The signal monitoring operation may be discontinuous reception (DRX) (e.g., DRX operation). The DRX operation of the terminal in the RRC connected state may be a connected-mode DRX (C-DRX) operation. In the present disclosure, DRX may refer to DRX or C-DRX depending on a context.

Meanwhile, in order to reduce power consumption of the terminal in the RRC connected state, a signal monitoring operation that consumes less power (e.g., low-power signal monitoring operation, low-power monitoring operation) than the existing signal monitoring operation and/or a low-power signal for the low-power signal monitoring operation may be considered. In order to reduce power consumption of the signal monitoring operation of the terminal in the communication network, a low-power wake-up signal (LP-WUS) and/or a low-power wake-up receiver (LP-WUR) may be considered. A power required for the terminal to monitor the low-power wake-up signal may be lower than a power required for the existing PDCCH monitoring and the like. The terminal may include a low-power wake-up receiver. The low-power wake-up receiver may be used to receive a low-power wake-up signal. A power consumption of the low-power wake-up receiver may be lower than a power consumption of an existing receiver (e.g., receiver that performs PDCCH monitoring and the like). The terminal may include the existing receiver and/or the low-power wake-up receiver. The terminal may receive an existing signal (e.g., PDCCH) using the existing receiver and receive the low-power wake-up signal using the low-power wake-up receiver. The existing receiver may refer to a main radio. In the present disclosure, the low-power wake-up signal may be referred to as a low-power signal or a wake-up signal for convenience, and the low-power wake-up receiver may be referred to as a low-power receiver or a wake-up receiver.

The base station may transmit a low-power wake-up signal. The terminal may monitor the low-power wake-up signal. The terminal may use the low-power wake-up receiver to monitor the low-power wake-up signal. The low-power wake-up receiver may be configured separately from the existing receiver of the terminal (e.g., signal receiver, main radio). In other words, the terminal may include the low-power wake-up receiver and the existing receiver.

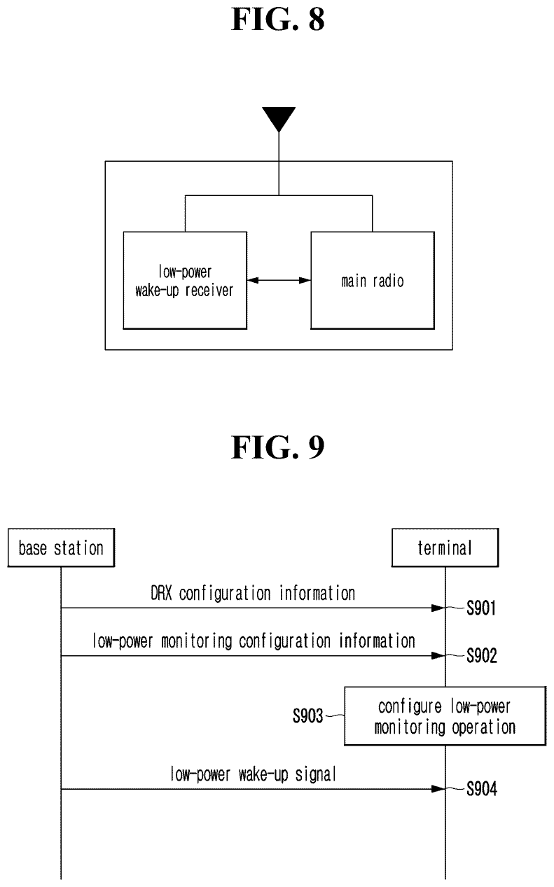

FIG. 8 is a block diagram illustrating exemplary embodiments of a communication node constituting a communication network.

Referring to FIG. 8, the terminal may include a main radio and a low-power wake-up receiver (e.g., low-power receiver). The main radio may refer to the existing receiver of the terminal. For example, the main radio and the low-power wake-up receiver may be configured within the same hardware, and within the same hardware, the main radio and the low-power wake-up receiver may be distinguished by software. In another example, the main radio and the low-power wake-up receiver may be configured as different hardware components. The terminal may receive a signal through an antenna. The received signal may be delivered to the main radio and/or the low-power wake-up receiver. In another example, antennas for the main radio and the low-power wake-up receiver may be independently configured within the terminal. In other words, the terminal may include a first antenna for the main radio and a second antenna for the low-power wake-up receiver. When a low-power wake-up signal is detected, the low-power wake-up receiver may deliver detection information of the low-power wake-up signal to the main radio. The main radio may receive the detection information of the low-power wake-up signal from the low-power wake-up receiver. The main radio may deliver information for operations of the low-power wake-up receiver to the low-power wake-up receiver, and the low-power wake-up receiver may receive the information for operations from the main radio.

The low-power wake-up signal may be a signal modulated using an on-off keying (OOK) scheme. The low-power wake-up signal may include encoded information. In other words, the low-power wake-up signal may be transmitted in form of encoded information. At least one of a channel code, cyclic redundancy check (CRC), or repeated transmission may be applied to information bits of the low-power wake-up signal, and the low-power wake-up signal may be transmitted. The low-power wake-up signal may be transmitted in form of a sequence. Depending on information that the base station intends to transmit, the low-power wake-up signal may be configured with a different sequence. The sequence may be a binary sequence.

A subcarrier spacing of the low-power wake-up signal may be the same as a subcarrier spacing used by the base station to transmit signals other than the low-power wake-up signal. For example, the subcarrier spacing of the low-power wake-up signal may be the same as a subcarrier spacing of a BWP (e.g., subcarrier spacing configured for the BWP). In another example, the subcarrier spacing of the low-power wake-up signal may be indicated by the base station. The base station may transmit subcarrier spacing information of the low-power wake-up signal to the terminal through a higher layer message or a system information block. The terminal may receive the subcarrier spacing information of the low-power wake-up signal through the higher layer message or system information block from the base station. The terminal may receive the low-power wake-up signal based on the subcarrier spacing information.

In another example, a predefined value may be used as the subcarrier spacing of the low-power wake-up signal. The base station may transmit the low-power wake-up signal using the predefined subcarrier spacing. The terminal may receive the low-power wake-up signal using the predefined subcarrier spacing. In another example, when the subcarrier spacing information of the low-power wake-up signal is received from the base station, the terminal may receive the low-power wake-up signal using the subcarrier spacing indicated by the base station. If the terminal does not receive the subcarrier spacing information of the low-power wake-up signal from the base station, the terminal may receive the low-power wake-up signal using the predefined subcarrier spacing (e.g., predefined value).

Monitoring for receiving the low-power wake-up signal may be configured for the low-power wake-up receiver. A scheme for monitoring the low-power wake-up signal may be the same as or similar to the exemplary embodiment of FIG. 6. The monitoring operation of the low-power wake-up signal may be performed periodically. The monitoring duration of the low-power wake-up signal may be periodically configured.

In the present disclosure, methods for monitoring the low-power wake-up signal by the low-power wake-up receiver will be described. The monitoring of the low-power wake-up signal (e.g., the monitoring operation of the low-power wake-up signal) may be referred to as low-power monitoring (e.g., low-power monitoring operation).

Before performing the low-power monitoring operation, the terminal may receive DRX configuration (e.g., DRX configuration information) through signaling (e.g., RRC configuration, RRC message) from the base station. The RRC configuration may refer to a configuration based on an RRC message. The DRX configuration may include at least one of a DRX cycle, a DRX time offset, a DRX on-duration timer (e.g., drx-onDurationTimer), or a DRX inactivity timer (e.g., drx-InactivityTimer). The DRX on-duration timer may be a timer for a DRX on-duration. The DRX inactivity timer may be a PDCCH detection termination timer that is initiated (e.g., started) when a PDCCH is detected within a DRX duration. The terminal may perform a DRX operation using the DRX configuration.

In the present disclosure, the low-power monitoring operation or the PDCCH monitoring operation may be referred to as a first monitoring operation, a second monitoring operation, a third monitoring operation, and the like, and the DRX on-duration timer or the DRX inactivity timer may be referred to as a first timer, a second timer, a third timer, and the like. A time duration based on a start (e.g., initiation) and an end (e.g., expiration) of the DRX on-duration timer may be referred to as a DRX on-duration timer duration, a DRX on-duration, a monitoring ON duration, and the like. A time duration based on a start (e.g., initiation) and an end (e.g., expiration) of the DRX inactivity timer may be referred to as a DRX inactivity timer duration, an extended DRX on-duration, an extended monitoring ON duration, and the like.

The terminal may receive information required for low-power monitoring through signaling (e.g., system information, RRC configuration) from the base station. The terminal may perform low-power monitoring using the information received from the base station. The signaling may refer to signaling based on at least one of system information, RRC message (e.g., RRC configuration), MAC CE, or DCI.

The terminal may receive a DRX configuration and/or a low-power monitoring configuration from the base station through signaling (e.g., system information, RRC configuration). The base station may transmit a single message including the DRX configuration and the low-power monitoring configuration to the terminal, and the terminal may obtain the DRX configuration and the low-power monitoring configuration by receiving the single message from the base station. The DRX configuration may refer to DRX configuration information, and the low-power monitoring configuration may refer to low-power monitoring configuration information. When the DRX configuration is received (e.g., when the DRX configuration is indicated to the terminal or the DRX is configured for the terminal), the terminal may receive the low-power monitoring configuration from the base station. When the DRX configuration is not received (e.g., when the DRX configuration is not indicated to the terminal or the DRX is not configured for the terminal), the terminal may not receive the low-power monitoring configuration from the base station. In other words, when the DRX configuration is not received (e.g., when the DRX configuration is not indicated to the terminal or the DRX is not configured for the terminal), the terminal may not expect to receive the low-power monitoring configuration from the base station. If the terminal that has not received the DRX configuration receives the low-power monitoring configuration from the base station, the terminal may not perform the low-power monitoring operation according to the low-power monitoring configuration.

In another example, the DRX configuration and the low-power monitoring configuration may be independently indicated (e.g., configured) to the terminal. If the terminal does not receive the DRX configuration from the base station but receives the low-power monitoring configuration from the base station, the terminal may perform the low-power monitoring operation according to the low-power monitoring configuration. In other words, the terminal may perform the low-power monitoring operation according to the low-power monitoring configuration regardless of whether the DRX configuration is received. If the terminal receives the DRX configuration and the low-power monitoring configuration from the base station, the terminal may perform the low-power monitoring operation based on the DRX configuration and the low-power monitoring configuration.

FIG. 9 is a conceptual diagram illustrating exemplary embodiments of a low-power monitoring operation in a communication network.

Referring to FIG. 9, a base station may generate DRX configuration information (e.g., DRX configuration). The base station may transmit the DRX configuration information to the terminal through signaling (S901). The terminal may receive the DRX configuration information from the base station (S901). The base station may generate low-power monitoring configuration information (e.g., monitoring configuration information of a low-power wake-up signal). The base station may transmit the low-power monitoring configuration information to the terminal through signaling (S902). The terminal may receive the low-power monitoring configuration information from the base station (S902). The terminal may configure a low-power monitoring operation based on the information received from the base station (e.g., DRX configuration information and/or low-power monitoring configuration information) (S903). The base station may transmit a low-power wake-up signal to the terminal (S904). The low-power wake-up signal may be transmitted based on the low-power monitoring configuration information. Alternatively, the low-power wake-up signal may be transmitted based on the DRX configuration information and the low-power monitoring configuration information. The terminal may receive the low-power wake-up signal by performing the low-power monitoring operation based on the information received from the base station (e.g., DRX configuration information and/or low-power monitoring configuration information) (S904). The low-power monitoring operation may be performed in one or more monitoring occasions (MOs) indicated by the low-power monitoring configuration information.

The low-power monitoring configuration information will be described. The base station may generate configuration information for low-power monitoring of the terminal (e.g., low-power monitoring configuration information) and may indicate the configuration information to the terminal. The low-power monitoring configuration information may include at least one of time information or frequency information for low-power monitoring. In other words, the low-power monitoring configuration information may include information on one or more MOs.

The frequency information for low-power monitoring (e.g., low-power monitoring frequency information) may indicate frequency resources (e.g., frequency positions) in which the low-power monitoring operation is performed. The low-power monitoring frequency information may be indicated by an offset from a reference position (e.g., reference frequency position). For example, the reference frequency position may be Point A. In another example, the reference frequency position may be the lowest PRB or the lowest subcarrier of an active BWP or an initial BWP in the frequency domain. In another example, the reference frequency position may be the lowest PRB or the lowest subcarrier of a CORESET. The terminal may monitor a low-power signal (e.g., low-power wake-up signal) in the frequency resources (e.g., frequency positions) indicated by the low-power monitoring frequency information.

The time information for low-power monitoring (e.g., low-power monitoring time information) may indicate time resources (e.g., time positions) in which the low-power monitoring operation is performed. The low-power monitoring time information may include monitoring cycle information of the low-power signal (e.g., low-power wake-up signal) and/or information (e.g., length information) on a monitoring duration of the low-power signal.

The low-power monitoring time information may include an offset indicating a time duration in which the terminal performs the low-power monitoring operation. The time duration in which the terminal performs the low-power monitoring operation may be indicated by an offset from a reference position (e.g., reference time position). For example, the reference time position may be a starting position of a DRX on-duration (e.g., on-duration). The DRX on-duration may refer to a duration in which the terminal performs a PDCCH monitoring operation based on the DRX configuration. The DRX off-duration (e.g., off-duration) may refer to a duration in which the terminal does not perform a PDCCH monitoring operation based on the DRX configuration. The PDCCH monitoring operation may be performed to receive a paging message. The paging message may be included in a PDSCH scheduled by a PDCCH or a PDCCH itself (e.g., paging PDCCH).

In another example, the reference time position may be a starting position of a duration based on the DRX on-duration timer (e.g., drx-onDurationTimer). In other words, the reference time position may be a starting position of the DRX on-duration timer. The terminal may transmit information for determining the offset to the base station. The information for determining the offset may include a minimum time duration (e.g., minimum time duration value, minimum time duration length). The minimum time duration may refer to an interval from an end time of the low-power monitoring operation to a duration (e.g., a start time or an ending time of a duration) in which a monitoring operation using the main radio of the terminal is performed. In other words, the minimum time duration may refer to the minimum time length from a time when the low-power receiver of the terminal receives the low-power wake-up signal to a time when the main radio of the terminal starts the monitoring operation (e.g., PDCCH monitoring operation). The base station may determine an offset (e.g., time offset) from a reception time of the low-power wake-up signal in the terminal to a start time of PDCCH monitoring in the terminal based on the minimum time duration indicated by the terminal. The base station may transmit information on the time offset to the terminal through signaling. The terminal may receive the information on the time offset through signaling from the base station.

The terminal may transmit information on one or more time durations (e.g., one or more time lengths) to the base station for determining the offset. The base station may receive information on the one or more time durations from the terminal. The base station may determine the offset using at least one of the one or more time durations. The terminal may transmit information (e.g., value, time duration) for determining the offset for each subcarrier spacing to the base station. The base station may determine the offset for each subcarrier spacing based on the information received from the terminal and may transmit information on the determined offset to the terminal. The terminal may receive information on the offset for each subcarrier spacing from the base station.

If the terminal transmits information on one or more time durations to the base station, the offset may be variably determined (e.g., configured) according to a configuration of the terminal (e.g., terminal state). The base station may variably apply the offset according to the configuration of the terminal (e.g., terminal state). The terminal state may refer to a signal monitoring state or a sleep state (e.g., sleep mode). The base station may variably apply the offset (e.g., time offset) according to a subcarrier spacing of an activated BWP.

The base station may determine the time offset by considering at least one of a processing time of a low-power signal (e.g., low-power wake-up signal) in the terminal, a wake-up time of the main radio of the terminal, a time required for time synchronization of the main radio of the terminal, or a time required for frequency synchronization of the main radio of the terminal. The time offset may indicate a time (e.g., start time or end time) of performing the low-power monitoring operation preceding the reference time position in the time domain. The terminal may monitor the low-power wake-up signal using the low-power monitoring time information.

The terminal may transmit at least one of the signal processing time of the low-power wake-up receiver, the wake-up time of the main radio, or the synchronization time of the main radio to the base station. At least one of the signal processing time of the low-power wake-up receiver, the wake-up time of the main radio, or the synchronization time of the main radio may be included in UE capability information (e.g., UE capability report) transmitted by the terminal to the base station. The base station may receive at least one of the signal processing time of the low-power wake-up receiver, the wake-up time of the main radio, or the synchronization time of the main radio from the terminal and may determine the time offset for the monitoring cycle of the low-power wake-up signal based on the received information. For example, the base station may determine the minimum value of the time offset for the monitoring cycle of the wake-up signal using at least one of the received information from the terminal and may determine the time offset based on the minimum value.

In another example, the terminal may determine a wake-up delay time based on at least one of the signal processing time of the low-power wake-up receiver, the wake-up time of the main radio, or the synchronization time of the main radio and may transmit information on the wake-up delay time to the base station. The wake-up delay time may refer to the minimum time length (e.g., minimum time interval) from a reception time of the low-power wake-up signal in the terminal to a start time of PDCCH monitoring using the main radio of the terminal. In other words, the wake-up delay time may refer to the minimum time length (e.g., minimum time interval) from a completion time of receiving the low-power wake-up signal in the terminal to a start time of the PDCCH monitoring operation in the terminal.

The terminal may transmit UE capability information, including the wake-up delay time (e.g., wake-up delay time information), to the base station. The base station may receive the UE capability information from the terminal and may identify the wake-up delay time information included in the UE capability information. The terminal may transmit information on one wake-up delay time among one or more wake-up delay times to the base station. The wake-up delay time may vary depending on a subcarrier spacing. The wake-up delay time may vary depending on a structure of the low-power wake-up receiver of the terminal. Depending on the structure of the low-power wake-up receiver, the low-power wake-up receiver may be classified into an OOK-based receiver and an OFDM-based receiver. The OOK-based receiver may receive an OOK signal (e.g., low-power signal generated using the OOK scheme), and the OFDM-based receiver may receive an OFDM signal (e.g., low-power signal generated using the OFDM scheme). The terminal may transmit information on one wake-up delay time for each subcarrier spacing to the base station. In another example, the terminal may transmit information on one or more wake-up delay times for each subcarrier spacing to the base station. In other words, the terminal may transmit information on one or more wake-up delay times to the base station. The base station may receive information on one or more wake-up delay times from the terminal. The base station may determine a time offset for a monitoring position of the low-power wake-up signal using the wake-up delay time information received from the terminal.

The terminal may transmit preferred time offset information (e.g., preferred offset information) to the base station through signaling (e.g., higher layer message, RRC message) in addition to the wake-up delay time information. The base station may receive the preferred time offset information from the terminal. The preferred time offset information may indicate one wake-up delay time among one or more wake-up delay times of the terminal. For example, among the wake-up delay times, a wake-up delay time that is equal to or greater than (e.g., exceeding) the wake-up delay time included in the UE capability information may be included in the preferred time offset information. In another example, among the wake-up delay times, a wake-up delay time that is equal to or less than (e.g., below) the wake-up delay time included in the UE capability information may be included in the preferred time offset information. The base station may determine a time offset using the wake-up delay time information and/or the preferred time offset information and may transmit information on the determined time offset to the terminal through signaling. The terminal may receive the information on the time offset through signaling from the base station.

The terminal may transmit information on a reference signal (i.e., reference signal information) required for synchronization estimation to the base station. The base station may receive the reference signal information from the terminal. The reference signal information may include at least one of information on the number of synchronization signal blocks (SSBs) received by the terminal for synchronization estimation or information on the number of tracking reference signals (TRSs) received by the terminal for synchronization estimation. The reference signal information may be included in UE capability information transmitted by the terminal to the base station. The terminal may transmit the reference signal information and the wake-up delay time information to the base station. The reference signal information may vary according to the wake-up delay time. Alternatively, the wake-up delay time may vary according to the reference signal information. For example, when the number of reference signals required for synchronization estimation increases, the wake-up delay time of the terminal may increase.

The low-power monitoring operation and detailed operations according to the low-power monitoring operation will be described.

The terminal may attempt to detect (e.g., receive) a low-power wake-up signal by performing the low-power monitoring operation. The low-power monitoring operation may be performed by the low-power receiver included in the terminal. When a low-power wake-up signal is detected, and the detected low-power wake-up signal indicates wake-up of the main radio, the terminal may perform a PDCCH monitoring operation at a predefined position. The predefined position may be a position indicated (e.g., configured) by the base station. The base station may indicate (e.g., configure) to the terminal the position where the PDCCH monitoring is performed through signaling (e.g., system information, RRC configuration). In another example, the position indicated by the base station may be a position independent of a detection position (e.g., time position) of the low-power wake-up signal. The time position may be the first DRX ON position (e.g., a start position of the first DRX on-duration) after the detection of the low-power wake-up signal. In other words, the time position may be a start time of the DRX on-duration timer (e.g., drx-onDurationTimer). The DRX on-duration timer may start after a time offset from the detection time of the low-power wake-up signal. If the DRX on-duration timer starts before the time offset from the detection time of the low-power wake-up signal, the terminal may not perform the PDCCH monitoring operation in the DRX on-duration based on the DRX on-duration timer. The PDCCH monitoring operation may be performed by the main radio included in the terminal.

As another example, the time position indicated by the base station may be determined based on a time offset from the detection time (e.g., position) of the low-power wake-up signal. The time position may be a time position after a time offset of X from the detection time of the low-power wake-up signal. X may be a natural number. X may indicate the number of symbols, slots, subframes, or frames. Alternatively, X may be set in milliseconds (ms). The base station may transmit a value of X to the terminal through signaling, and the terminal may identify the value of X through signaling from the base station.

If a low-power wake-up signal is not detected, the terminal may not perform the PDCCH monitoring operation regardless of the DRX on-duration and/or the DRX off-duration. If a low-power wake-up signal is not detected, the terminal may perform low-power monitoring in the next monitoring duration of the low-power wake-up signal. A wake-up indication may indicate transition of the operating state of the terminal (e.g., the main radio of the terminal) from a sleep mode to an active mode. Performing wake-up may refer to the transition of the operating state of the terminal (e.g., the main radio of the terminal) from a sleep mode to an active mode.

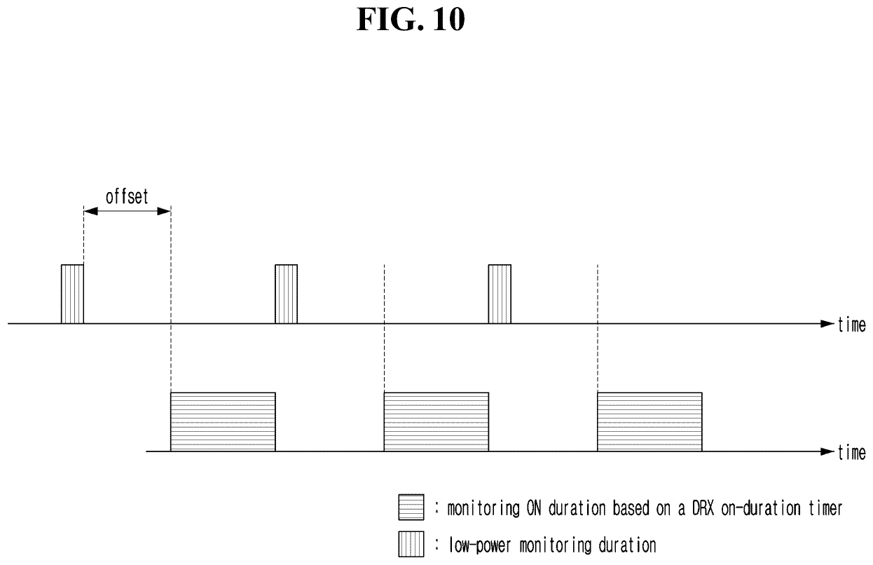

FIG. 10 is a conceptual diagram illustrating exemplary embodiments of a low-power monitoring operation in a communication network.

Referring to FIG. 10, the terminal may determine (e.g., identify) a monitoring ON duration of the main radio based on the DRX configuration. The monitoring ON duration may be determined based on the DRX on-duration timer (e.g., drx-onDurationTimer). For example, a time interval from a start time to an end time of the DRX on-duration timer may correspond to the monitoring ON duration. The monitoring ON duration may be a DRX on-duration (e.g., on-duration). The monitoring ON duration may periodically exist. In other words, the monitoring ON duration may be periodically configured. The terminal may start the DRX on-duration timer at a start time of the monitoring ON duration and may perform a monitoring operation (e.g., PDCCH monitoring operation) using the main radio in the monitoring ON duration. When the DRX on-duration timer expires (e.g., when the monitoring ON duration ends), the terminal may stop the monitoring operation.

The terminal may perform the low-power monitoring operation (e.g., monitoring operation of a low-power wake-up signal) before a time offset from the start time of the monitoring ON duration (e.g., monitoring ON duration of the main radio). The low-power monitoring operation may be performed by the low-power receiver of the terminal. The base station may indicate (e.g., configure) the time offset to the terminal. If a low-power wake-up signal is detected through the low-power monitoring operation and the detected low-power wake-up signal indicates wake-up of the main radio, the terminal may perform the PDCCH monitoring operation in the monitoring ON duration using the main radio. During the PDCCH monitoring operation performed in the monitoring ON duration, the terminal may not perform the low-power monitoring operation. If a PDCCH is detected in the monitoring ON duration, the monitoring ON duration may be extended based on the DRX inactivity timer (e.g., drx-Inactivity Timer). The terminal may not perform the low-power monitoring operation in the extended monitoring ON duration.

If a low-power wake-up signal is not detected through the low-power monitoring operation or if a detected low-power wake-up signal does not indicate wake-up of the main radio, the terminal may not perform the PDCCH monitoring operation in the monitoring ON duration. The terminal may perform the low-power monitoring operation in the next low-power monitoring duration.

The terminal may perform the low-power monitoring operation based on information indicated by the base station. If a low-power wake-up signal is detected through the low-power monitoring operation and the detected low-power wake-up signal includes a wake-up indication for the terminal (e.g., the main radio), the terminal may perform the PDCCH monitoring operation in a monitoring ON duration. If a low-power wake-up signal is detected through the low-power monitoring operation and the detected low-power wake-up signal does not include a wake-up indication for the terminal (e.g., the main radio), the terminal may not perform the PDCCH monitoring operation in a monitoring ON duration. If a low-power wake-up signal is not detected through the low-power monitoring operation, the terminal may stop the low-power monitoring operation and may perform a C-DRX-based monitoring operation. The C-DRX-based monitoring operation may refer to a PDCCH monitoring operation. A position where the C-DRX-based monitoring operation is performed when a low-power wake-up signal is not detected may be the same as a position where the PDCCH monitoring operation is performed when a low-power wake-up signal is detected and the detected low-power wake-up signal indicates wake-up. Alternatively, the position where the C-DRX-based monitoring operation is performed when a low-power wake-up signal is not detected may be the same as a position of the next duration (e.g., the next duration according to the DRX cycle) after the duration in which the PDCCH monitoring operation is performed when a low-power wake-up signal is detected and the detected low-power wake-up signal indicates wake-up.

In a time duration other than the time duration in which the low-power monitoring operation and the PDCCH monitoring operation are performed according to the exemplary embodiment of FIG. 10, the terminal may perform the low-power monitoring operation and/or the PDCCH monitoring operation. The terminal may perform the low-power monitoring operation in a time duration other than the time duration corresponding to the monitoring ON duration of the main radio (e.g., a start time of the monitoring ON duration). If a low-power wake-up signal is detected in a time duration other than the time duration corresponding to the monitoring ON duration of the main radio (e.g., a start time of the monitoring ON duration) and the detected low-power wake-up signal indicates wake-up of the main radio, the terminal may perform the PDCCH monitoring operation using the main radio.

The terminal may receive the low-power monitoring configuration information from the base station regardless of the C-DRX configuration. The terminal may perform the low-power monitoring operation based on the low-power monitoring configuration information. The low-power monitoring configuration information may include at least one of a low-power monitoring cycle, a time offset for a low-power monitoring duration, or information on the low-power monitoring duration (e.g., the length of the low-power monitoring duration).

If a low-power wake-up signal is detected in a time duration other than the time duration corresponding to the monitoring ON duration of the main radio (e.g., a start time of the monitoring ON duration), and the detected low-power wake-up signal indicates wake-up of the main radio, the terminal may perform the PDCCH monitoring operation using the main radio after a time offset from a detection time of the low-power wake-up signal. The time offset may be a time offset indicated (e.g., configured) by the base station. The terminal may perform the PDCCH monitoring operation during a monitoring ON duration 2 (e.g., DRX on-duration 2) based on a DRX on-duration timer 2 (e.g., drx-onDurationTimer2) after the time offset from the detection time of the low-power wake-up signal.

The length of the monitoring ON duration 2 based on the DRX on-duration timer 2 (e.g., drx-onDurationTimer2) may be independently configured from the length of the monitoring ON duration based on the DRX on-duration timer (e.g., drx-onDurationTimer) according to the C-DRX configuration. For example, the length of the monitoring ON duration 2 may differ from the length of the monitoring ON duration. Alternatively, the length of the monitoring ON duration 2 may be the same as the length of the monitoring ON duration. The monitoring ON duration may be referred to as ‘monitoring ON duration 1’ to distinguish it from the monitoring ON duration 2. The monitoring ON duration 1 may refer to a first monitoring ON duration, and the monitoring ON duration 2 may refer to a second monitoring ON duration.

The terminal may not perform the low-power monitoring operation while performing the PDCCH monitoring operation in the monitoring ON duration 2. If a PDCCH is detected through the PDCCH monitoring operation in the monitoring ON duration 2, the monitoring ON duration 2 may be extended based on a DRX inactivity timer 2 (e.g., drx-InactivityTimer2). The terminal may not perform the low-power monitoring operation in the extended monitoring ON duration 2.

If a low-power wake-up signal is not detected through the low-power monitoring operation or if a detected low-power wake-up signal does not indicate wake-up of the main radio, the terminal may not perform the PDCCH monitoring operation in the monitoring ON duration 2 of the main radio. The terminal may monitor a low-power wake-up signal in the low-power monitoring duration of the next cycle.

The terminal may perform the low-power monitoring operation based on information indicated by the base station. If a low-power wake-up signal is detected through the low-power monitoring operation and the detected low-power wake-up signal indicates wake-up, the terminal may perform the PDCCH monitoring operation. If a low-power wake-up signal is detected through the low-power monitoring operation and the detected low-power wake-up signal does not indicate wake-up, the terminal may not perform the PDCCH monitoring operation. If a low-power wake-up signal is not detected through the low-power monitoring operation, the terminal may stop the low-power monitoring operation and perform the C-DRX-based monitoring operation. The C-DRX-based monitoring operation may refer to the PDCCH monitoring operation. A position where the C-DRX-based monitoring operation is performed when a low-power wake-up signal is not detected may be the same as a position (e.g., start position) of a monitoring ON duration after a time offset from a detection time of a low-power wake-up signal when the low-power wake-up signal is detected and the detected low-power wake-up signal indicates wake-up. The time offset may be a time offset indicated by the base station.

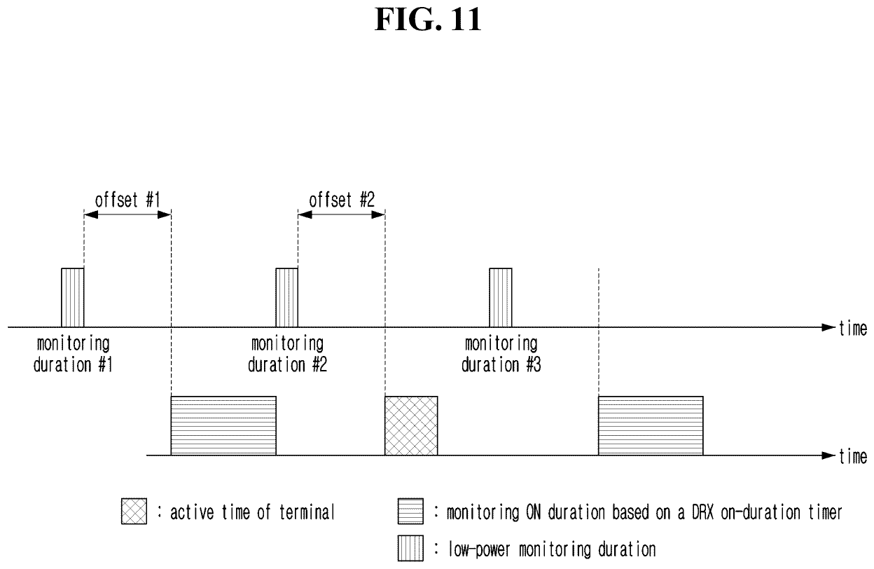

FIG. 11 is a conceptual diagram illustrating exemplary embodiments of a low-power monitoring operation in a communication network.

Referring to FIG. 11, the terminal may perform the low-power monitoring operation in a time duration (e.g., monitoring duration #1, monitoring duration #3) corresponding to a monitoring ON duration based on a DRX on-duration timer (e.g., the monitoring ON duration of the main radio). If a low-power wake-up signal is detected in the time duration and the detected low-power wake-up signal indicates wake-up of the main radio, the terminal may perform the PDCCH monitoring operation using the main radio from a start time of the monitoring ON duration. The terminal may perform the low-power monitoring operation in a time duration (e.g., monitoring duration #2) that does not correspond to the monitoring ON duration. The low-power monitoring operation (e.g., the low-power monitoring cycle) may be independently configured from the C-DRX cycle. If a low-power wake-up signal is detected in the time duration and the detected low-power wake-up signal indicates wake-up of the main radio, the terminal may perform the PDCCH monitoring operation using the main radio after a time offset (e.g., offset #2) from a detection time of the low-power wake-up signal. The offset #2 may be an offset indicated by the base station. The offset #1 may be referred to as a first offset, and the offset #2 may be referred to as a second offset.

Similarly or identically to the exemplary embodiment shown in FIG. 10, the terminal may start the low-power monitoring operation before a time offset from a start time of a monitoring ON duration, and if a low-power wake-up signal detected through the low-power monitoring operation indicates wake-up of the main radio, the terminal may a PDCCH monitoring operation in the monitoring ON duration. The above-described monitoring scheme may be referred to as a first monitoring scheme.

In order to configure the first monitoring scheme, a time offset (e.g., first time offset) from a start time of a DRX-on duration timer (e.g., monitoring ON duration) may be configured. The base station may indicate the first time offset to the terminal through signaling (e.g., higher layer message, RRC configuration). The terminal may identify the first time offset indicated by the signaling from the base station. The terminal may determine a start time of the low-power monitoring operation based on the first time offset. As an exemplary embodiment of configuring the first monitoring scheme, a cycle and/or offset for low-power monitoring may be configured using environmental parameter(s) separate from the C-DRX configuration.

For example, a cycle and/or offset (hereinafter referred to as ‘first cycle/offset’) for monitoring based on the C-DRX configuration may be configured to the terminal, and a cycle and/or offset (hereinafter referred to as ‘second cycle/offset’) for low-power monitoring may be configured to the terminal. The first cycle/offset and the second cycle/offset may be independently configured. The terminal may perform the low-power monitoring operation based on the first cycle/offset and/or the second cycle/offset. The first time offset may refer to a time offset from a start time of the low-power monitoring operation to a monitoring position based on the C-DRX configuration (e.g., a start time of a monitoring operation). The monitoring position based on the C-DRX configuration may refer to a start time of a DRX on-duration timer according to the C-DRX configuration. The monitoring position based on the C-DRX configuration may refer to a start time of a slot in which the DRX on-duration timer starts according to the C-DRX configuration.

The terminal may perform the low-power monitoring operation from a time preceding the monitoring position based on the C-DRX configuration by the first time offset. The terminal may perform the low-power monitoring operation for X low-power monitoring durations (e.g., low-power monitoring occasions) starting from the start time of the low-power monitoring operation. The low-power monitoring occasions may be referred to as MOs (e.g., low-power MOs). The low-power monitoring operation may be performed X times in X MOs. The value of X may be a natural number. The value of X may be a value indicated by the base station. The base station may indicate the value of X to the terminal through signaling (e.g., higher layer message, RRC configuration). The terminal may identify the value of X indicated by the signaling from the base station. The terminal may determine whether wake-up is indicated by performing the low-power monitoring operation in X MOs.

When a wake-up indication (e.g., low-power wake-up signal) is detected through the low-power monitoring operation, the terminal may perform a signal monitoring operation (e.g., PDCCH monitoring operation) from a start time of the DRX on-duration timer, which is a reference time for the first time offset. When a wake-up indication is not detected through the low-power monitoring operation, the terminal may not perform the signal monitoring operation (e.g., PDCCH monitoring operation) from the start time of the DRX on-duration timer, which is the reference time for the first time offset. In other words, the terminal may not perform signal monitoring in the monitoring ON duration based on the DRX on-duration timer. The terminal may perform the low-power monitoring operation in the next low-power monitoring duration based on the second cycle/offset.

The terminal may not perform the monitoring operation for a low-power wake-up signal during a time duration close to the start time of the DRX on-duration timer. The time duration close to the start time of the DRX on-duration timer may be a time duration preceding the start time of the DRX on-duration timer in the time domain. The time duration close to the start time of the DRX on-duration timer may be defined as a first time duration. The first time duration may be configured in units of symbols, slots, subframes, frames, MOs, or milliseconds. In the present disclosure, a symbol may refer to an OFDM symbol. The first time duration may be a predefined time duration in the communication system (e.g., communication network). Alternatively, the first time duration may be a time duration indicated by the base station. The first time duration may be configured as Y symbols, Y slots, Y subframes, Y frames, Y MOs, or Y milliseconds. The value of Y may be a natural number. The terminal may not perform the low-power monitoring operation during Y symbols, Y slots, Y subframes, Y frames, Y MOs, or Y milliseconds preceding the start time of the DRX on-duration timer.

Within a time duration from a time corresponding to the first time offset to the start time of the DRX on-duration timer, Z MOs may exist. The value of Z may be a natural number. The terminal may not perform the low-power monitoring operation for Y MOs preceding the start time of the DRX on-duration timer. The terminal may perform the low-power monitoring operation in a time before the first time offset from the start time of the DRX on-duration timer, and the low-power monitoring operation may be performed in (Z-Y) MOs (or symbols, slots, subframes, or frames). Z-Y may be equal to X.

X symbols, X slots, X subframes, X frames, or X MOs may exist after a time preceding the start time of the DRX on-duration timer by the first time offset. The base station may indicate a value indicating Y MOs among Z MOs to the terminal through signaling. The terminal may identify the value of Y indicated by the signaling from the base station. The terminal may identify the value of X based on the value of Y.

As another exemplary embodiment of configuring the first monitoring scheme, the cycle and/or offset for the low-power monitoring operation may be set to be the same as the cycle and/or offset according to the DRX on-duration timer based on the C-DRX configuration. In this case, the terminal may perform the low-power monitoring operation using the cycle and/or offset according to the DRX on-duration timer.

In the exemplary embodiment illustrated in FIG. 11, the low-power monitoring cycle may be configured independently of the C-DRX cycle. When a low-power wake-up signal indicates wake-up of the main radio, the terminal may perform the PDCCH monitoring operation using the main radio after a time offset from a detection time of the low-power wake-up signal. The above-described scheme may be referred to as a second monitoring scheme.

Based on the configuration of the second monitoring scheme, a time offset (hereinafter referred to as ‘second time offset’) from a detection time of a low-power wake-up signal to a time (e.g., start time) of performing a PDCCH monitoring operation may be configured. The base station may indicate the second time offset to the terminal through signaling (e.g., higher layer message, RRC configuration). The terminal may identify the second time offset indicated by the signaling from the base station. The second time offset may be set in units of symbols, slots, subframes, frames, or milliseconds.

The second time offset may indicate a time duration from an end time of the low-power wake-up signal to the time of performing the PDCCH monitoring operation. The end time of the low-power wake-up signal may refer to a time when the low-power wake-up signal, which includes a wake-up indication, ends. The end time of the low-power wake-up signal may be an end time of a symbol, slot, subframe, or frame in which the low-power wake-up signal including the wake-up indication ends.

A cycle and/or offset (hereinafter referred to as ‘third cycle/offset’) for low-power monitoring may be set. The third cycle/offset may be indicated by the base station. For example, the base station may indicate the third cycle/offset to the terminal through signaling (e.g., higher layer message, RRC configuration). The terminal may determine the third cycle/offset indicated by the signaling from the base station.

The terminal may perform the low-power monitoring operation using the third cycle/offset. By performing the low-power monitoring operation, the terminal may detect a low-power wake-up signal. The terminal may determine whether the base station indicates wake-up based on the detected low-power wake-up signal.

The terminal may perform the low-power monitoring operation using the third cycle/offset. Based on the third cycle/offset, the terminal may perform the low-power monitoring operation for X MOs (e.g., X low-power MOs) starting from a start time of a low-power monitoring duration. The value of X may be a natural number. The value of X may be indicated by the base station. The base station may indicate the value of X to the terminal through signaling (e.g., higher layer message, RRC configuration). The terminal may identify the value of X indicated by the signaling from the base station. By performing the low-power monitoring operation in X MOs, the terminal may determine whether the base station indicates wake-up. The low-power monitoring operation may be performed N times in X MOs.

When a wake-up indication (e.g., low-power wake-up signal including a wake-up indication) is detected through the wake-up monitoring operation, the terminal may perform a PDCCH monitoring operation in a time duration after the second time offset from an end time of the low-power wake-up signal. The terminal may start the DRX on-duration timer 2 after the second time offset from the end time of the low-power wake-up signal. The DRX on-duration timer 2 may be a timer configured independently of the DRX on-duration timer for the C-DRX operation. The terminal may perform a PDCCH monitoring operation during a time duration corresponding to the DRX on-duration timer 2 after the second time offset from the end time of the low-power wake-up signal. The PDCCH monitoring operation may be performed until an expiration time of the DRX on-duration timer 2. The base station may transmit information on the DRX on-duration timer 2 (e.g., drx-onDurationTimer2) to the terminal through signaling (e.g., higher layer message, RRC configuration). The terminal may receive information on the DRX on-duration timer 2 through signaling from the base station. Based on the information received from the base station, the terminal may perform the PDCCH monitoring operation during the time duration corresponding to the DRX on-duration timer 2 after the second time offset from the end time of the low-power wake-up signal.

When a wake-up indication (e.g., low-power wake-up signal including a wake-up indication) is not detected through the wake-up monitoring operation, the terminal may not perform the PDCCH monitoring operation. The terminal may perform the low-power monitoring operation in the next low-power monitoring duration based on the third cycle/offset.

Regarding the first monitoring scheme and the second monitoring scheme, information (e.g., length information) on the low-power monitoring duration may be indicated to the terminal through signaling from the base station (e.g., higher layer message, RRC configuration). The terminal may perform the low-power monitoring operation based on the information (e.g., low-power monitoring duration information) indicated by the signaling from the base station

The terminal may receive the C-DRX configuration (e.g., C-DRX configuration information) from the base station through signaling (e.g., higher layer message, RRC configuration). The configuration of the first monitoring scheme and the configuration of the second monitoring scheme may be independently indicated (e.g., configured) to the terminal. The base station may transmit the configuration (e.g., configuration information) of the first monitoring scheme and/or the configuration (e.g., configuration information) of the second monitoring scheme to the terminal through signaling (e.g., higher layer message, RRC configuration). The terminal may receive the configuration (e.g., configuration information) of the first monitoring scheme and/or the configuration (e.g., configuration information) of the second monitoring scheme through signaling from the base station. The configuration of the first monitoring scheme may be referred to as a first monitoring configuration, and the configuration of the second monitoring scheme may be referred to as a second monitoring configuration. The configuration information of the first monitoring scheme may be referred to as first monitoring configuration information, and the configuration information of the second monitoring scheme may be referred to as second monitoring configuration information. The terminal may receive one of the first monitoring configuration or the second monitoring configuration for a cell (e.g., serving cell). In other words, the terminal may not receive both the first monitoring configuration and the second monitoring configuration for a cell.

When the terminal receives the C-DRX configuration from the base station, the terminal may receive the first monitoring configuration from the base station. When the terminal does not receive the C-DRX configuration from the base station, the terminal may not receive the first monitoring configuration from the base station. In other words, when the C-DRX configuration is not received, the terminal may not expect to receive the first monitoring configuration from the base station. When the terminal receives the C-DRX configuration from the base station, the terminal may receive the second monitoring configuration from the base station. When the terminal does not receive the C-DRX configuration from the base station, the terminal may not receive the second monitoring configuration from the base station. In other words, when the C-DRX configuration is not received, the terminal may not expect to receive the second monitoring configuration from the base station. In another example, the terminal may receive the second monitoring configuration from the base station regardless of whether the C-DRX configuration is received. When the terminal receives the C-DRX configuration from the base station, the terminal may receive the first monitoring configuration and/or the second monitoring configuration. When the terminal does not receive the C-DRX configuration from the base station, the terminal may not receive the first monitoring configuration and/or the second monitoring configuration. The terminal may receive the first monitoring configuration and/or the second monitoring configuration regardless of whether the C-DRX configuration is received.

As an exemplary embodiment of monitoring configuration for a low-power wake-up signal, the terminal may receive one or more low-power monitoring configurations from the base station. A low-power monitoring cycle based on the low-power monitoring configuration may be the same as a DRX cycle of the terminal. Alternatively, the low-power monitoring cycle based on the low-power monitoring configuration may be a multiple or a fraction of the DRX cycle of the terminal. For example, the low-power monitoring cycle may be set to 1/N of the DRX cycle T. The value of N may be a natural number. In another example, the low-power monitoring cycle may be set to N times the DRX cycle T. The low-power monitoring cycle may be configured to not exceed a long C-DRX cycle.

The base station may transmit information (e.g., length information) on the low-power monitoring duration to the terminal through signaling. The terminal may receive the low-power monitoring duration information through signaling from the base station. The length of the low-power monitoring duration may be indicated to the terminal in form of a timer. The terminal may start the low-power monitoring operation at a start time of a predefined time duration. The terminal may initiate the timer while performing the low-power monitoring operation. When the timer expires, the terminal may terminate the low-power monitoring operation. The terminal may initialize the timer in a low-power monitoring duration of the next cycle.

In a time duration in which the main radio of the terminal performs the PDCCH monitoring operation, the terminal (e.g., low-power receiver of the terminal) may not perform the low-power monitoring operation. The terminal may not perform the low-power monitoring operation in a time duration in which radio resource management (RRM) is performed. The terminal may not perform the low-power monitoring operation in a time duration in which channel state information (CSI) measurement reporting or reference signal received power (RSRP) measurement reporting is performed.

A start time of a PDCCH monitoring operation according to detection of a low-power wake-up signal and/or an wake-up indication may be configured differently depending on the low-power monitoring configuration. When the low-power monitoring cycle is set to be the same as the DRX cycle, the terminal may start a PDCCH monitoring operation at a start time of a DRX on-duration timer of the main radio. When the low-power monitoring cycle is set to 1/N or N times the DRX cycle, the terminal may start a PDCCH monitoring operation after a time offset from a reception position (e.g., reception time) of the low-power wake-up signal. The time offset may be indicated to the terminal by the base station. The time offset may correspond to the time offset in the exemplary embodiments of FIG. 10 and/or FIG. 11. In the exemplary embodiment of FIG. 11, the lengths of the offset #1 and the offset #2 may be the same.

The terminal may monitor a low-power wake-up signal in a time duration corresponding to the DRX on-duration timer of the main radio. The terminal may start a low-power monitoring operation from a start time of the DRX on-duration timer according to the DRX configuration. When a low-power wake-up signal is detected and the detected low-power wake-up signal indicates wake-up, the terminal may perform a PDCCH monitoring operation. A start time of the PDCCH monitoring operation may be a certain time after a detection time of the low-power wake-up signal. The PDCCH monitoring operation may be performed during a time duration corresponding to the DRX on-duration timer of the main radio. The PDCCH monitoring operation may be performed until a DRX inactivity timer (e.g., drx-InactivityTimer) expires.

When a low-power wake-up signal is not detected or a detected low-power wake-up signal does not indicate wake-up, the terminal may not perform a PDCCH monitoring operation. The terminal may perform the low-power monitoring operation in a duration corresponding to a DRX on-duration timer of the next cycle.

The PDCCH monitoring operation may be performed until the timer (e.g., time timer) expires. In another example, the PDCCH monitoring operation may be performed until a specific indication is received from the base station. The specific indication may be received through a MAC CE of the base station.

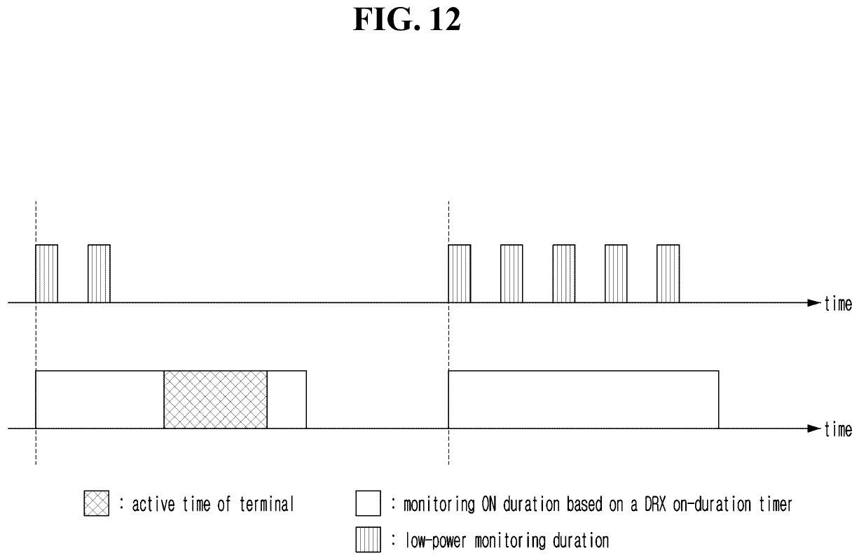

FIG. 12 is a conceptual diagram illustrating exemplary embodiments of a low-power monitoring operation in a communication network.

Referring to FIG. 12, the terminal may start monitoring a low-power wake-up signal in a time duration corresponding to a DRX on-duration timer. The terminal may periodically perform the low-power monitoring operation in the time duration corresponding to the DRX on-duration timer. When a low-power wake-up signal is detected and the detected low-power wake-up signal indicates wake-up, the terminal may perform a PDCCH monitoring operation. The PDCCH monitoring operation may be performed during an active time of the terminal. When a low-power wake-up signal is not detected in the time duration corresponding to the DRX on-duration timer or a detected low-power wake-up signal does not indicate wake-up, the terminal may perform the low-power monitoring operation in the next time duration corresponding to the DRX on-duration timer.

The terminal may perform monitoring of a low-power wake-up signal regardless of a monitoring duration of the main radio. When a low-power wake-up signal is detected and the detected low-power wake-up signal indicates wake-up, the terminal may perform a PDCCH monitoring operation after a certain time from that time point (e.g., detection time of the low-power wake-up signal). When a low-power wake-up signal is detected and the detected low-power wake-up signal indicates wake-up, the terminal may activate (e.g., initiate, start) a timer. The terminal may perform a PDCCH monitoring operation until the timer expires. When a PDCCH is detected through the PDCCH monitoring operation, the timer may be reset. When a low-power wake-up signal is not detected or a detected low-power wake-up signal does not indicate wake-up, the terminal may perform low-power monitoring in the next low-power monitoring duration.

CSI reporting based on a wake-up indication will be described. The terminal may periodically perform CSI reporting to the base station. The terminal may periodically perform RSRP reporting to the base station. The RSRP reporting may be included in CSI reporting. The RSRP may refer to Layer 1 (L1) reference signal received power (RSRP). The terminal may perform periodic CSI reporting and/or periodic RSRP reporting according to whether a wake-up indication is received, based on a configuration of the base station. The base station may transmit configuration information for CSI reporting (e.g., periodic CSI reporting) and/or RSRP reporting (e.g., periodic RSRP reporting) to the terminal through signaling (e.g., higher layer message, RRC configuration). The configuration information may indicate activation (e.g., activation of the configuration) of periodic CSI reporting and/or periodic RSRP reporting of the terminal receiving the low-power wake-up signal. The configuration information for CSI reporting (e.g., periodic CSI reporting) and/or RSRP reporting (e.g., periodic RSRP reporting) may be referred to as reporting configuration information.

When the terminal receives the reporting configuration information and a low-power wake-up signal detected by the terminal indicates wake-up, the terminal may perform periodic CSI reporting and/or periodic RSRP reporting using a DRX active time. When the terminal receives the reporting configuration information but does not receive a wake-up indication through a low-power wake-up signal, the terminal may perform periodic CSI reporting and/or periodic RSRP reporting during a time duration corresponding to the DRX on-duration timer. The time duration corresponding to the DRX on-duration timer may be a time duration corresponding to the DRX on-duration timer based on the DRX configuration.

When the terminal does not receive the reporting configuration information and does not receive a wake-up indication through a low-power wake-up signal, the terminal may not perform periodic CSI reporting and/or periodic RSRP reporting. When the terminal does not receive the reporting configuration information but receives a wake-up indication through a low-power wake-up signal, the terminal may perform periodic CSI reporting and/or periodic RSRP reporting using a DRX active time.

The DRX operation, PDCCH skipping (e.g., PDCCH monitoring skipping), and/or low-power monitoring operation will be described.

The terminal may receive a DRX configuration. The terminal may perform a PDCCH monitoring operation in a time duration corresponding to a DRX on-duration timer according to the DRX configuration. The terminal may receive a PDCCH skipping indication in the time duration corresponding to the DRX on-duration timer, which is a PDCCH monitoring duration. The PDCCH skipping indication may indicate that the terminal stops performing the PDCCH monitoring operation for a specific time duration. The terminal may not perform the PDCCH monitoring operation during the time duration indicated by the base station (e.g., the time duration to which the PDCCH skipping indication is applied). The terminal may perform the low-power monitoring operation during the PDCCH skipping duration. The PDCCH skipping duration may be a duration to which the PDCCH skipping indication is applied.

The terminal may receive the PDCCH skipping indication from the base station and may detect a low-power wake-up signal within a time duration in which the PDCCH monitoring operation is not performed based on the PDCCH skipping indication. When a low-power wake-up signal is detected within the PDCCH skipping duration and the detected low-power wake-up signal indicates wake-up, the terminal may perform the PDCCH monitoring operation. When a low-power wake-up signal is detected within the PDCCH skipping duration and the detected low-power wake-up signal indicates wake-up, the terminal may perform the PDCCH monitoring operation after a time offset (e.g., after a time offset from a detection time of the low-power wake-up signal). The time offset may be indicated to the terminal by the base station.

When a low-power wake-up signal is detected within the PDCCH skipping duration and the detected low-power wake-up signal indicates wake-up, the terminal may perform the PDCCH monitoring operation. In this case, an end time of the PDCCH monitoring operation will be described. The terminal may perform the PDCCH monitoring operation until an end time (e.g., expiration time) of the DRX on-duration timer. As another example, the terminal may perform the PDCCH monitoring operation until an end time (e.g., expiration time) of a DRX inactivity timer. As another example, the terminal may perform the PDCCH monitoring operation until an end time (e.g., expiration time) of a timer related to the low-power monitoring operation and/or the PDCCH skipping indication.

When a PDCCH skipping indication is received while the PDCCH monitoring operation is being performed, the terminal may not perform the PDCCH monitoring operation during a time duration to which the PDCCH skipping indication is applied. During the time duration in which the PDCCH monitoring operation is not performed (e.g., the time duration to which the PDCCH skipping indication is applied), the terminal may perform a reception operation of a reference signal (e.g., CSI-RS, etc.).

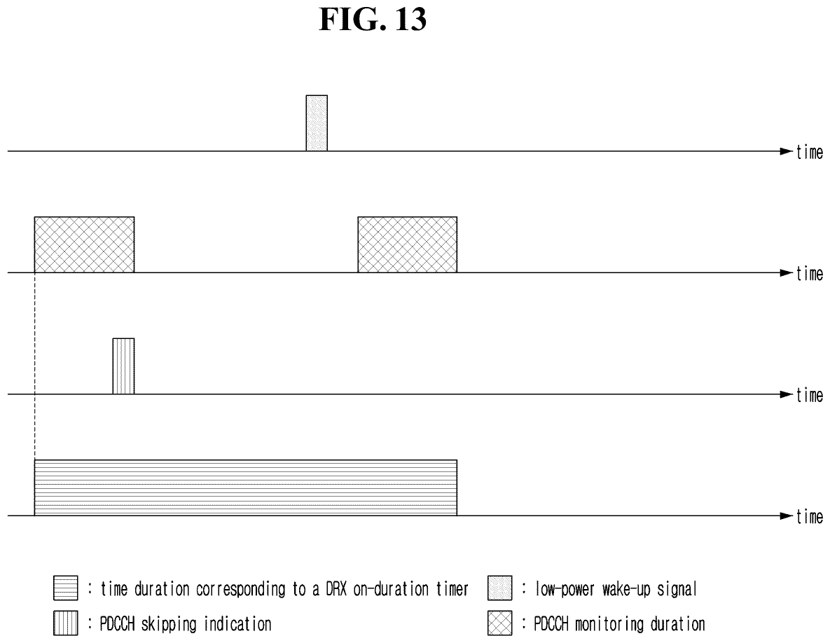

FIG. 13 is a conceptual diagram illustrating exemplary embodiments of a low-power monitoring operation in a communication network.

Referring to FIG. 13, the terminal may perform a PDCCH monitoring operation in a time duration corresponding to a DRX on-duration timer according to a DRX configuration. In the present disclosure, the time duration corresponding to the DRX on-duration timer may be referred to as a DRX on-duration timer duration. The terminal may receive a PDCCH skipping indication from the base station while performing the PDCCH monitoring operation. The PDCCH skipping indication may be received based on at least one of system information, RRC message, MAC CE, or DCI. The terminal may stop the PDCCH monitoring operation based on the PDCCH skipping indication. The terminal may perform the low-power monitoring operation within a time duration in which the PDCCH monitoring operation is stopped based on the PDCCH skipping indication. By performing the low-power monitoring operation, the terminal may receive a low-power wake-up signal. The low-power wake-up signal may indicate to perform the PDCCH monitoring operation. Alternatively, the low-power wake-up signal may indicate wake-up of the main radio. The terminal may perform the PDCCH monitoring operation and/or the wake-up operation of the main radio based on the indication of the low-power wake-up signal.

The simultaneous configuration of the low-power monitoring operation, DRX operation, PDCCH skipping indication, and/or DCI for power saving (DCP) will be described. The terminal may receive DRX configuration information (e.g., DRX configuration) and low-power monitoring configuration information (e.g., low-power monitoring configuration). The DRX configuration information and the low-power monitoring configuration information may be received simultaneously. “The DRX configuration information and the low-power monitoring configuration information are received simultaneously” may mean “the DRX configuration information and the low-power monitoring configuration information are received in the same time duration” or “one of the DRX configuration information and the low-power monitoring configuration information is received first and then the other configuration information is received”. In other words, “the DRX configuration information and the low-power monitoring configuration information are received simultaneously” may mean “both the DRX configuration and the low-power monitoring configuration are indicated to the terminal”.

The terminal may receive the low-power monitoring configuration information and PDCCH skipping configuration information (e.g., PDCCH skipping configuration) simultaneously. The terminal may not receive the low-power monitoring configuration information and DCP configuration information (e.g., DCP configuration) simultaneously. The terminal may expect to receive one of the two configurations (e.g., two pieces of configuration information) from the base station. When both configurations are received, the terminal may perform an operation based on one of the configurations. For example, when the terminal receives both the low-power monitoring configuration and the DCP configuration, the terminal may perform an operation based on the low-power monitoring configuration. In this case, the terminal may not perform an operation based on the DCP configuration. In another example, when the terminal receives both the low-power monitoring configuration and the DCP configuration, the terminal may perform an operation based on the DCP configuration. In this case, the terminal may not perform an operation based on the low-power monitoring configuration.

Activation and deactivation of the low-power monitoring operation will be described.

The base station may transmit low-power monitoring configuration information to the terminal through signaling (e.g., higher layer message, RRC configuration). The terminal may receive the low-power monitoring configuration information through signaling from the base station. The terminal may perform the low-power monitoring operation based on the low-power monitoring configuration information.

The terminal may receive an activation indication for the low-power monitoring operation separately from the low-power monitoring configuration information through signaling from the base station. When the activation indication is received, the terminal may perform the low-power monitoring operation. When the terminal receives the low-power monitoring configuration information but does not receive the activation indication, the terminal may not perform the low-power monitoring operation. The terminal may receive a deactivation indication for the low-power monitoring operation. When the terminal receives the deactivation indication for the low-power monitoring operation, the terminal may stop performing the low-power monitoring operation.

The base station may transmit the activation indication and/or deactivation indication for the low-power monitoring operation to the terminal through signaling (e.g., system information, higher layer message, RRC configuration, MAC CE, physical layer message, and/or DCI). The terminal may receive the activation indication and/or the deactivation indication for the low-power monitoring operation through signaling from the base station.

The terminal may receive one or more low-power monitoring configurations from the base station. The terminal may receive an activation indication or a deactivation indication for at least one of the received low-power monitoring configurations from the base station. When the activation indication is received, the terminal may perform the low-power monitoring operation based on at least one low-power monitoring configuration to which the activation indication is applied. When the deactivation indication is received, the terminal may stop performing the low-power monitoring operation based on at least one low-power monitoring configuration to which the deactivation indication is applied.

Activation or deactivation of the low-power monitoring operation may be indicated using methods other than those described above.

For example, when the terminal performs an uplink transmission, the terminal may deactivate the low-power monitoring operation. The uplink transmission of the terminal may include transmissions such as PUSCH, PUCCH, SRS, physical random access channel (PRACH), and scheduling request (SR). The terminal may deactivate the low-power monitoring operation for a certain time after the uplink transmission. When the terminal performs an uplink transmission while the low-power monitoring operation is activated, the terminal may wake up the main radio. The terminal may perform a transmission operation of an existing signal, a reception operation of an existing signal, and/or a monitoring operation of an existing signal through the main radio. The existing signal may be referred to as a legacy signal. The legacy signal may not include a low-power signal. The terminal may activate the low-power monitoring operation after a certain time following the uplink transmission. The terminal may initiate a timer after the uplink transmission and may activate the low-power monitoring operation when the timer expires. When the terminal performs an uplink transmission, the timer may be reset.

As another example, when the terminal detects a low-power wake-up signal, and the detected low-power wake-up signal indicates wake-up of the main radio, the terminal may deactivate the low-power monitoring operation. When the terminal detects a low-power wake-up signal, and the detected low-power wake-up signal indicates wake-up of the main radio, the terminal may activate the PDCCH monitoring operation of the main radio. When the PDCCH monitoring operation of the main radio (e.g., PDCCH detection operation) is activated, the terminal may deactivate the low-power monitoring operation. When the main radio of the terminal does not perform the PDCCH monitoring operation, the terminal may activate the low-power monitoring operation.

When the terminal detects a low-power wake-up signal, and the detected low-power wake-up signal indicates wake-up of the main radio, the terminal may deactivate the low-power monitoring operation for a certain period. When the terminal detects a low-power wake-up signal, and the detected low-power wake-up signal does not indicate wake-up of the main radio, the terminal may activate the low-power monitoring operation after a certain period. When the terminal detects a low-power wake-up signal, and the detected low-power wake-up signal indicates wake-up of the main radio, the terminal may initiate (e.g., set) a timer, and when the timer expires, the terminal may activate the low-power monitoring operation. The terminal may perform the PDCCH monitoring operation until the timer expires. The timer may be initiated (e.g., activated) after a time offset from a reception time of the low-power wake-up signal. The time offset may be a wake-up delay time. Alternatively, the time offset may be a value indicated (e.g., set) by the base station.

When the PDCCH monitoring operation (e.g., PDCCH detection operation) of the main radio is activated, the terminal may deactivate the low-power monitoring operation for a certain period. When the PDCCH monitoring operation (e.g., PDCCH detection operation) of the main radio is activated, the terminal may activate the low-power monitoring operation after a certain period. When the PDCCH monitoring operation (e.g., PDCCH detection operation) of the main radio is activated, the terminal may initiate (e.g., set) a timer, and when the timer expires, the terminal may activate the low-power monitoring operation. When the PDCCH monitoring operation (e.g., PDCCH detection operation) of the main radio is activated, the terminal may initiate (e.g., set) a timer, and the terminal may perform the PDCCH monitoring operation until the timer expires. The timer may be initiated (e.g., activated) after a time offset from a reception time of the low-power wake-up signal. The time offset may be a wake-up delay time. Alternatively, the time offset may be a value indicated (e.g., set) by the base station.

When C-DRX is configured for the terminal, the terminal may not perform the low-power monitoring operation during a C-DRX active time. When C-DRX is configured for the terminal, the terminal may not perform the low-power monitoring operation during a DRX on-duration timer duration.

When the main radio of the terminal does not perform the PDCCH monitoring operation, the terminal may activate the monitoring operation of a low-power wake-up signal (e.g., low-power monitoring operation). When an activation indication for the low-power monitoring operation is received in the main radio of the terminal, the terminal (e.g., the low-power receiver of the terminal) may activate the low-power monitoring operation.

A reporting method for an execution state of the low-power monitoring operation will be described. The terminal may report information indicating whether the low-power monitoring operation is performed to the base station. When the terminal does not perform the low-power monitoring operation, the terminal may report information indicating that the low-power monitoring operation is not performed to the base station. When the terminal performs the low-power monitoring operation, the terminal may report information indicating that the low-power monitoring operation is performed to the base station. The base station may identify whether the terminal performs the low-power monitoring operation based on the report from the terminal.

When the terminal performs the low-power monitoring operation, the terminal may perform RRM using the low-power receiver. When the terminal does not perform the low-power monitoring operation, the terminal may perform RRM using the main radio. The terminal may transmit an RRM result obtained using the low-power wake-up receiver and/or the main radio to the base station. The base station may receive the RRM result from the terminal and identify whether the terminal performs the low-power monitoring operation based on the RRM result.

When an uplink transmission of the terminal is received at the base station, the base station may determine that the terminal does not perform the low-power monitoring operation.

When a specific condition is satisfied while the terminal performs the low-power monitoring operation, the terminal may stop the low-power monitoring operation and perform the PDCCH monitoring operation based on the C-DRX configuration. For example, when a low-power wake-up signal is not detected by the low-power monitoring operation at a position indicated by a time offset received from the base station, the terminal may perform the PDCCH monitoring operation according to the C-DRX configuration. “A low-power wake-up signal is not detected” may mean “a low-power wake-up signal itself is not detected” rather than “a low-power wake-up signal does not include a wake-up indication”.

As another example, when a low-power wake-up signal is not detected for a certain time duration, the terminal may perform the PDCCH monitoring operation according to the C-DRX configuration. For example, when the terminal fails to detect a low-power wake-up signal for a time duration exceeding a threshold or for a low-power monitoring duration exceeding a threshold, the terminal may perform the PDCCH monitoring operation according to the C-DRX configuration.

As another example, when it is determined that a channel state or beam state is not suitable for receiving a low-power wake-up signal, the terminal may perform the PDCCH monitoring operation according to the C-DRX configuration. For example, when a result of a channel state measurement (e.g., channel state measurement value) or a result of a beam measurement (e.g., beam measurement value) is equal to or less than a threshold, the terminal may perform the PDCCH monitoring operation according to the C-DRX configuration.

A payload of a low-power wake-up signal will be described. The payload size of the low-power wake-up signal may be variable. The payload size of the low-power wake-up signal may be indicated to the terminal through a higher layer message (e.g., RRC configuration). The terminal may identify the payload size of the low-power wake-up signal using the information indicated by the base station. The payload size of the low-power wake-up signal may be configured differently depending on an RRC state of the terminal. For example, the payload size of the low-power wake-up signal for a terminal in the RRC connected state may be configured differently from the payload size of the low-power wake-up signal for a terminal in the RRC idle/inactive state. The terminal may determine the payload size of the low-power wake-up signal based on the RRC state of the terminal.

The base station may transmit a wake-up indication for waking up the terminal. For example, the base station may generate a bitmap for one or more terminal groups and may indicate whether to wake up each terminal group using the bitmap. The terminal group may include one or more terminals. The bitmap may include one or more bits, and each bit in the bitmap may correspond to each terminal group. The base station may toggle bit(s) corresponding to terminal group(s) that are wake-up targets among the bits in the bitmap, and the base station may not toggle the remaining bits in the bitmap. The base station may indicate wake-up for the terminal group(s) by transmitting the bitmap. The terminal may receive the bitmap from the base station, and when the bit corresponding to a terminal group to which the terminal belongs is toggled in the bitmap, the terminal may perform wake-up. When the bit corresponding to the terminal group to which the terminal belongs is not toggled in the bitmap, the terminal may not perform wake-up.

As another example, a terminal group identifier (ID) (e.g., terminal group ID) may be configured. The base station may indicate wake-up for a terminal group by transmitting a terminal group ID for the terminal group that is a wake-up target. The terminal may receive the terminal group ID from the base station. When the terminal belongs to the terminal group having the terminal group ID, the terminal may perform wake-up. When the terminal does not belong to the terminal group having the terminal group ID (e.g., when the terminal group ID for the terminal group to which the terminal belongs is not received from the base station), the terminal may not perform wake-up.

As another example, the base station may indicate wake-up for one or more terminal groups by transmitting a code point indicating wake-up for the one or more terminal groups. For example, one code point may correspond to one sequence or one piece of information transmitted through the low-power wake-up signal. One code point may be mapped to one or more terminal groups. The terminal group may include one or more terminals. One code point may be mapped to one terminal group. Alternatively, one code point may be mapped to all terminal groups. A code point that individually indicates wake-up for each terminal group may be configured. For example, when there are N terminal groups, N code points that respectively indicate wake-up for the N terminal groups may be configured. N may be a natural number. A code point that indicates wake-up for all terminal groups may be configured. For example, when there are N terminal groups, one code point that indicates wake-up for all N terminal groups may be configured. The terminal may receive a code point from the base station. When the code point indicates wake-up for a terminal group to which the terminal belongs, the terminal may perform wake-up. When the code point does not indicate wake-up for the terminal group to which the terminal belongs (e.g., when a code point for the terminal group to which the terminal belongs is not received from the base station), the terminal may not perform wake-up.

A low-power wake-up signal and an SSB may be transmitted using the same beam (e.g., transmission beam). The terminal may assume that a relationship between the low-power wake-up signal and the SSB is a quasi-co-location (QCL) relationship. A low-power wake-up signal and a CSI-RS may be transmitted using the same beam. The terminal may assume that a relationship between the low-power wake-up signal and the CSI-RS is a QCL relationship. A low-power wake-up signal and a PDCCH/CORESET may be transmitted using the same beam. The transmission of the PDCCH/CORESET may refer to DCI transmission. The terminal may assume that a relationship between the low-power wake-up signal and the PDCCH/CORESET (e.g., DCI) is a QCL relationship. The base station may transmit QCL information of the low-power wake-up signal to the terminal. The terminal may identify the QCL information of the low-power wake-up signal by receiving the QCL information of the low-power wake-up signal from the base station.

The communication network may support a carrier aggregation operation. The carrier aggregation operation may be configured in the base station and/or the terminal. In the communication network that supports the carrier aggregation operation, a wake-up operation of the terminal using a low-power wake-up signal may be performed. An operation related to a low-power wake-up signal may be configured on one carrier (e.g., serving cell) among the aggregated carriers. In other words, a low-power wake-up signal may be transmitted and received in a serving cell. The base station may transmit a low-power wake-up signal to the terminal in one serving cell. The terminal may receive a low-power wake-up signal from the base station in one serving cell. Even when the terminal supports the carrier aggregation operation and a low-power wake-up signal is received in one serving cell, an indication according to the low-power wake-up signal may be applied to all serving cells (e.g., all serving carriers). The application of the indication according to the low-power wake-up signal to all serving cells may mean “the main radio of the terminal is woken up for all serving cells” and/or “the terminal performs PDCCH monitoring operation in all serving cells”.

One DRX group may be configured in the communication network. Configuring one DRX group may mean that dual DRX groups are not configured. A low-power wake-up signal may be transmitted in one or more serving cells. In other words, in the communication network that supports the carrier aggregation operation, a low-power wake-up signal may be transmitted in one or more serving cells. The terminal may perform the low-power monitoring operation in a cell #N. N may be a natural number. The cell #N may be one serving cell. The terminal may perform the low-power monitoring operation using the low-power receiver. The terminal may receive a low-power wake-up signal in the cell #N, and the received low-power wake-up signal may include a wake-up indication for the terminal. The cell #N may be a primary cell (PCell). Alternatively, the cell #N may be a cell indicated through a higher layer message (e.g., RRC configuration). The terminal may perform wake-up of the main radio of the terminal for an activated cell. When a low-power wake-up signal is received (e.g., when the received low-power wake-up signal includes an wake-up indication for the terminal), the terminal may perform wake-up for the activated cell. Performing wake-up may mean that the terminal performs the PDCCH monitoring operation.

Dual DRX groups may be configured in the communication network. A low-power wake-up signal may be configured for each DRX group. A low-power wake-up signal may be transmitted for each DRX group. The low-power wake-up signal may include a wake-up signal (e.g., wake-up indication) for each DRX group. The terminal may receive the low-power wake-up signal for each DRX group from the base station. When a wake-up indication (e.g., low-power wake-up signal) for a specific DRX group is received, the terminal may perform wake-up for all cells belonging to the specific DRX group (e.g., all activated cells, all serving cells). The low-power wake-up signal may be configured regardless of the DRX group. The low-power wake-up signal may be transmitted in one cell (e.g., one serving cell). The low-power wake-up signal may include a wake-up signal (e.g., wake-up indication) for all cells (e.g., all serving cells). The terminal may receive the low-power wake-up signal from the base station. When the wake-up indication (e.g., low-power wake-up signal) is received, the terminal may perform wake-up for all cells belonging to all DRX groups (e.g., all activated cells, all serving cells).

The communication network may support a dual connectivity operation. The dual connectivity operation may be configured to the base station and/or the terminal. In the communication network that supports the dual connectivity operation, a wake-up operation of the terminal using a low-power wake-up signal may be supported. The terminal (e.g., main radio of the terminal) in the communication network may perform dual connectivity for a master cell group (MCG) and a secondary cell group (SCG).

The terminal may perform the low-power monitoring operation in one or more cells belonging to the MCG. The terminal may perform the low-power monitoring operation in one or more cells belonging to the SCG. The base station may transmit a low-power wake-up signal in one or more cells belonging to the MCG. The base station may transmit a low-power wake-up signal in one or more cells belonging to the SCG. The terminal may receive the low-power wake-up signal in one or more cells belonging to the MCG. The terminal may receive the low-power wake-up signal in one or more cells belonging to the SCG. The one or more cells belonging to the MCG may be a PCell. The one or more cells belonging to the SCG may be a primary secondary cell (PSCell). The one or more cells may be cells indicated through a higher layer message (e.g., RRC configuration). The terminal may receive the low-power wake-up signal (e.g., wake-up indication) using the low-power receiver.

The terminal may wake up the main radio based on an indication of the low-power wake-up signal received in the one or more cells belonging to the MCG. When the low-power wake-up signal (e.g., wake-up indication) is received in the one or more cells belonging to the MCG, the terminal may perform wake-up for all cells of the MCG (e.g., all activated cells, all serving cells). Performing wake-up may mean performing the PDCCH monitoring operation. When the wake-up indication (e.g., low-power wake-up signal) is received in the one or more cells belonging to the MCG, the terminal may not perform wake-up for the cells of the SCG.

The terminal may wake up the main radio based on the indication of the low-power wake-up signal received in one or more cells belonging to the SCG. When the low-power wake-up signal (e.g., wake-up indication) is received in one or more cells belonging to the SCG, the terminal may perform wake-up for all cells of the SCG (e.g., all activated cells, all serving cells). Performing wake-up may mean performing the PDCCH monitoring operation. When the wake-up indication (e.g., low-power wake-up signal) is received in one or more cells belonging to the SCG, the terminal may not perform wake-up for the cells of the MCG.

The terminal may perform the low-power monitoring operation in one or more cells belonging to the MCG or in one or more cells belonging to the SCG. The base station may transmit the low-power wake-up signal in one or more cells belonging to the MCG or in one or more cells belonging to the SCG. The terminal may receive the low-power wake-up signal in one or more cells belonging to the MCG or in one or more cells belonging to the SCG. The one or more cells belonging to the MCG may be a PCell. The one or more cells belonging to the SCG may be a PSCell. The one or more cells may be cells indicated through a higher layer message (e.g., RRC configuration). The terminal may receive the low-power wake-up signal (e.g., wake-up indication) using the low-power receiver.

The terminal may wake up the main radio based on the indication of the low-power wake-up signal received in one or more cells belonging to the MCG or in one or more cells belonging to the SCG. When a low-power wake-up signal (e.g., wake-up indication) is received in one or more cells belonging to the MCG or in one or more cells belonging to the SCG, the terminal may perform wake-up for all cells of the MCG (e.g., all activated cells, all serving cells) and all cells of the SCG (e.g., all activated cells, all serving cells). Performing wake-up may mean performing the PDCCH monitoring operation.

The wake-up operation for the cell group of the terminal according to the wake-up indication may be indicated to the terminal by the base station. The base station may indicate the terminal to perform wake-up for the activated cell(s) in the MCG when a wake-up indication is received in one or more cells belonging to the MCG″. The base station may indicate the terminal to perform wake-up for the activated cell(s) in the SCG when a wake-up indication is received in one or more cells belonging to the SCG″. The base station may indicate the terminal to perform wake-up for the activated cell(s) in the MCG and/or the SCG when a wake-up indication is received in one or more cells belonging to the MCG or one or more cells belonging to the SCG. The base station may transmit the indication to the terminal through signaling (e.g., higher layer message, RRC configuration). The terminal may receive the indication from the base station and perform the wake-up operation for the cell group(s) according to the reception of the wake-up indication based on the indication.

When the communication network supports dual connectivity and two DRX groups are configured, a low-power wake-up signal may be configured for each cell group and/or each DRX group. For example, the low-power wake-up signal for the MCG and the low-power wake-up signal for the SCG may be independently configured. The low-power wake-up signal for the first DRX group and the low-power wake-up signal for the second DRX group may be independently configured. The low-power wake-up signal may include a wake-up indication for each cell group and/or each DRX group. The terminal may receive the low-power wake-up signal for each cell group and/or each DRX group. When a wake-up indication (e.g., low-power wake-up signal) for a cell group and/or a DRX group is received, the terminal may perform wake-up for the activated cell(s) (e.g., serving cell) in the cell group and/or DRX group.

When the communication network supports dual connectivity and two DRX groups are configured, a low-power wake-up signal may be configured for each DRX group. For example, the low-power wake-up signal for the first DRX group and the low-power wake-up signal for the second DRX group may be independently configured. The low-power wake-up signal may include a wake-up signal for each DRX group. The terminal may receive the low-power wake-up signal for each DRX group. When the wake-up indication for a specific DRX group (e.g., low-power wake-up signal) is received, the terminal may perform wake-up for the activated cell(s) (e.g., serving cell) in all cell groups belonging to the specific DRX group.

When the communication network supports dual connectivity and two DRX groups are configured, a low-power wake-up signal may be configured for each cell group. For example, the low-power wake-up signal for the MCG and the low-power wake-up signal for the SCG may be independently configured. The low-power wake-up signal may include a wake-up indication for each cell group. The terminal may receive the low-power wake-up signal for each cell group. When the wake-up indication (e.g., low-power wake-up signal) for a specific cell group is received, the terminal may perform wake-up for the activated cell(s) (e.g., serving cell) in all DRX group(s) belonging to the specific cell group.

The communication network may support cell discontinuous transmission (DTX)/DRX operation. The cell DTX/DRX operation may be configured in the base station and/or the terminal. In the communication network that supports the cell DTX/DRX operation, a wake-up operation of the terminal using a low-power wake-up signal may be performed. The base station in the communication network may perform the cell DTX/DRX operation. The base station may transmit cell DTX/DRX configuration information to the terminal through signaling. The terminal may identify the cell DTX/DRX configuration information by receiving the cell DTX/DRX configuration information from the base station. The terminal may perform the low-power monitoring operation based on the cell DTX/DRX configuration information. The terminal may perform the low-power monitoring operation during a time duration in which a cell DTX/DRX on-duration timer (e.g., cellDTX-DRX-onDurationTimer) is activated (e.g., initiated, started) based on the cell DTX/DRX configuration information. The terminal may not perform the low-power monitoring operation during a time duration in which the cell DTX/DRX on-duration timer (e.g., cellDTX-DRX-onDurationTimer) is not activated (e.g., not initiated, not started) based on the cell DTX/DRX configuration information.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
performing a first monitoring operation in a monitoring occasion to receive a low-power wake-up signal; and
in response to receipt of the low-power wake-up signal indicating wake-up of the terminal from a base station, performing a physical downlink control channel (PDCCH) monitoring operation after a first offset from a reception time of the low-power wake-up signal.

2. The method according to claim 1, further comprising: receiving configuration information for the first monitoring operation from the base station,
wherein the configuration information includes at least one of a cycle or an offset of the monitoring occasion.

3. The method according to claim 2, wherein each of the cycle or the offset of the monitoring occasion is set independently from a cycle or an offset of a discontinuous reception (DRX) configured for the terminal.

4. The method according to claim 1, wherein the performing of the PDCCH monitoring operation comprises:
starting a first timer after the first offset from the reception time of the low-power wake-up signal; and
performing the PDCCH monitoring operation in a time duration corresponding to the first timer.

5. The method according to claim 1, further comprising: in response to that the low-power wake-up signal is not received from the base station or that the low-power wake-up signal received from the base station does not indicate wake-up of the terminal, performing the first monitoring operation for receiving the low-power wake-up signal in the monitoring occasion of a next cycle.

6. The method according to claim 1, wherein the PDCCH monitoring operation is performed to receive a paging message from the base station.

7. The method according to claim 1, wherein the first offset is configured to the terminal by signaling of the base station.

8. The method according to claim 1, wherein the first monitoring operation is performed by a low-power receiver included in the terminal, and the PDCCH monitoring operation is performed by a main radio included in the terminal.

9. The method according to claim 1, wherein when the terminal supports a carrier aggregation operation and the low-power wake-up signal is received from one serving cell, a wake-up indication according to the low-power wake-up signal is applied to all serving cells.

10. The method according to claim 1, wherein when the terminal supports a dual connectivity operation and the low-power wake-up signal is received from one serving cell within a cell group, a wake-up indication according to the low-power wake-up signal is applied to all serving cells within the cell group.

11. A terminal comprising at least one processor, wherein the at least one processor causes the terminal to perform:
performing a first monitoring operation in a monitoring occasion to receive a low-power wake-up signal; and
in response to receipt of the low-power wake-up signal indicating wake-up of the terminal from a base station, performing a physical downlink control channel (PDCCH) monitoring operation after a first offset from a reception time of the low-power wake-up signal.

12. The terminal according to claim 11, wherein the at least one processor further causes the terminal to perform: receiving configuration information for the first monitoring operation from the base station,
wherein the configuration information includes at least one of a cycle or an offset of the monitoring occasion.

13. The terminal according to claim 12, wherein each of the cycle or the offset of the monitoring occasion is set independently from a cycle or an offset of a discontinuous reception (DRX) configured for the terminal.

14. The terminal according to claim 11, wherein in the performing of the PDCCH monitoring operation, the at least one processor causes the terminal to perform:
starting a first timer after the first offset from the reception time of the low-power wake-up signal; and
performing the PDCCH monitoring operation in a time duration corresponding to the first timer.

15. The terminal according to claim 11, wherein the at least one processor further causes the terminal to perform: in response to that the low-power wake-up signal is not received from the base station or that the low-power wake-up signal received from the base station does not indicate wake-up of the terminal, performing the first monitoring operation for receiving the low-power wake-up signal in the monitoring occasion of a next cycle.

16. The terminal according to claim 11, wherein the PDCCH monitoring operation is performed to receive a paging message from the base station.

17. The terminal according to claim 11, wherein the first offset is configured to the terminal by signaling of the base station.

18. The terminal according to claim 11, further comprising a low-power receiver and a main radio,
wherein the first monitoring operation is performed by the low-power receiver, and the PDCCH monitoring operation is performed by the main radio.

19. The terminal according to claim 11, wherein when the terminal supports a carrier aggregation operation and the low-power wake-up signal is received from one serving cell, a wake-up indication according to the low-power wake-up signal is applied to all serving cells.

20. The terminal according to claim 11, wherein when the terminal supports a dual connectivity operation and the low-power wake-up signal is received from one serving cell within a cell group, a wake-up indication according to the low-power wake-up signal is applied to all serving cells within the cell group.
